(19) United States
(12) Patent Application Publication
(10) Pub. No.: US 2026/0368807 A1
(43) Pub. Date: Nov. 19, 2026

(54) SYSTEMS AND METHODS FOR DEBT CONSOLIDATION PLATFORM WITH PARTITION-AWARE CREDIT CARD DEBT OPTIMIZATION

(71) Applicant: PAYPLANR, INC., Rancho Cordova, CA (US)

(72) Inventor: Andrew Liszewski, Rancho Cordova, CA (US)

(21) Appl. No.: 19/554,469

(22) Filed: Mar. 2, 2026

Related U.S. Application Data
(60) Provisional application No. 63/806,226, filed on May 15, 2025.
(60) Provisional application No. 63/922,925, filed on Nov. 21, 2025.

(51) Int. Cl. G06Q 40/03

(52) U.S. Cl. CPC G06Q 40/034; G06Q 40/03055; G06Q 40/039

(57) ABSTRACT

Disclosed herein are systems, methods, and computer-readable media providing a debt consolidation platform configured to manage partition-aware repayment of credit card debt. In some embodiments, the debt consolidation platform ingests data records associated with credit accounts from financial institutions. The platform may parse the data records to populate a sub-balance data structure with a plurality of sub-balance entries, compute a time-dependent effective APR for each sub-balance entry based on a current timestamp, generate a ranked priority list by sorting sub-balance entries according to effective APRs, allocate an available payment amount using a constrained optimization routine, and/or generate a payment schedule object including monthly payment allocations and a predicted debt-free completion date. The platform may automatically detect restructuring events and/or regenerate the payment schedule object to produce a comparison visualization. In some embodiments, the platform provides a hypothetical scenario test interface through which users may evaluate hypothetical financial scenarios.

### CROSS-REFERENCE TO RELATED APPLICATION(S)

This application claims priority to and the benefits of U.S. Provisional Patent Application No. 63/806,226, entitled “System and Method for Aggregating and Personalizing Balance Transfer and Debt Consolidation Offers Based on User Financial Data,” filed on May 15, 2025, and U.S. Provisional Patent Application No. 63/922,925, entitled “System and Method for Partition-Aware Credit Card Debt Optimization with Time-Dependent Effective APR Calculation,” filed on Nov. 21, 2025. The content of the aforementioned applications are herein incorporated by reference in their entirety.

### BACKGROUND

A credit card is a payment card, usually issued by a bank, allowing its users to purchase goods or services, or withdraw cash, on credit. Using the card thus accrues debt that has to be repaid later. Credit cards are one of the most widely used forms of payment across the world.

Credit card debt results when a client of a credit card company purchases an item or service through the card system. Debt grows through the accrual of interest and penalties when the consumer fails to repay the company for the money they have spent. If the debt is not paid on time, the company will charge a late-payment penalty and report the late payment to credit rating agencies. Late payment is sometimes referred to as “default”. The late-payment penalty increases the customer's total debt.

### BRIEF DESCRIPTION OF THE DRAWINGS

Reference will now be made, by way of example, to the accompanying drawings, which show example embodiments of the present application, and in which:

FIG. 1 illustrates an example of a debt consolidation environment providing a debt consolidation platform.

FIG. 2 illustrates a second example of a debt consolidation environment providing a debt consolidation platform.

FIG. 3 illustrates a third example of a debt consolidation environment providing a debt consolidation platform.

FIG. 4 illustrates an example of a user interface of a debt consolidation platform displaying a sub-balance data structure.

FIG. 5 illustrates a second example of a user interface of a debt consolidation platform displaying sub-balance entries associated with a financial institution.

FIG. 6 illustrates an example of a payment schedule interface of a debt consolidation platform.

FIG. 7 illustrates an example of a restructuring event interface of a debt consolidation platform.

FIG. 8 provides an example of a comparison visualization between a payment schedule object and a regenerated payment schedule object, within a comparison interface of a debt consolidation platform.

FIG. 9 illustrates an example of a balance transfer interface of a debt consolidation platform, including balance transfer offers.

FIG. 10 illustrates an example of a hypothetical scenario test interface of a debt consolidation platform.

FIG. 11 illustrates a second example of a payment schedule interface of a debt consolidation platform.

FIG. 12 is a flow diagram illustrating an example method for calculating time-dependent effective APRs.

FIG. 13 is a flow diagram illustrating an example method for partition-aware credit card debt payment optimization executed by a debt consolidation platform to manage repayment of credit card debt.

FIG. 14 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Conventional debt management systems suffer from significant limitations that hinder effective credit card debt repayment planning. These conventional systems often accept financial data (e.g., balance amount, minimum payment amount, interest rate) provided via manual entry by users, or financial data aggregator-provided values, but the conventional systems lack a capability to derive underlying formula parameters that govern how those values evolve over time. For example, while a financial aggregator can provide a conventional debt management system with a current minimum payment amount, such conventional systems are often unable to receive or derive issuer-specific formula parameters, such as minimum payment percentage, floor amount, and/or formula type, which are parameters necessary for debt management systems to effectively project the evolution of minimum payment amounts over time, as balances change.

Conventional systems likewise often fail to interface effectively with financial institutions, requiring users to gather information from multiple sources and re-enter data each time account balances change. Furthermore, conventional systems often model each credit account as a singular unit with a single interest rate, failing to account for a partition structure of many modern credit card accounts where different balance types such as regular purchases, balance transfers, and/or cash advances carry different annual percentage rates and promotional terms.

Conventional debt management systems also fail to automatically recalculate payment schedules in response to changes in a user's debt portfolio. When a user makes an extra payment, accepts a balance transfer offer, or experiences expiration of a promotional interest rate, conventional systems require the user to manually initiate recalculation or restart the planning process entirely. Such a limitation of conventional systems provides a flawed platform that prevents users from understanding real-time impact of financial decisions on a debt repayment trajectory. Conventional systems also fail to provide meaningful comparison visualizations that quantify an impact of financial changes.

The present technology addresses the limitations of conventional systems and provides a partition-aware debt consolidation platform that interfaces with financial institutions to automatically ingest financial data and dynamically recalculate payment schedules in response to restructuring events. The debt consolidation platform may model each credit card account, or credit account, including multiple sub-balances, each with independent balance amounts, regular interest rates, promotional interest rates, and promotional expiration dates. Such a partition-level granularity of the present technology provides debt consolidation optimization at a far finer level than conventional account-level or institution-level systems, accounting for the varying interest rates and promotional terms that apply to different portions of a user's debt. Further, the present technology addresses the structural data limitations of conventional systems (e.g., the inability to derive issuer-specific formula parameters for values such as minimum payment amount) by deriving said issuer-specific parameters using data across multiple input channels, which can enable forward projection of minimum payments, fees, and balance evolution across a planning horizon.

The present technology further improves upon conventional systems by calculating time-dependent effective interest rates that account for promotional expiration dates, enabling forward-looking planning that may anticipate future rate changes rather than reacting to rate changes upon occurrence. In some embodiments, the debt consolidation platform automatically detects restructuring events, updates underlying data structures, and regenerates payment schedules without requiring user-initiated recalculation. The debt consolidation platform may present comparison visualizations that quantify an impact of financial changes through presenting metrics such as debt-free completion date deltas and interest savings deltas, providing improved, in-depth metrics to users.

In some embodiments, the present technology provides a data structure that stores individual sub-balance entries with fields for balance amounts, regular interest rates, promotional interest rates, and promotional expiration timestamps. The partition-aware data structure enables the platform to track and optimize across sub-balances from different credit accounts issued by different financial institutions. In some embodiments, the present technology evaluates whether a current date precedes or follows each promotional expiration date and assigns an effective interest rate accordingly. This time-dependent calculation allows the platform to prioritize payment allocation based on current effective rates while anticipating future rate transitions.

In some embodiments, the present technology generates ranked priority lists and/or allocates available payment amounts using constrained optimization routines. The debt consolidation platform may sort sub-balance entries according to computed effective interest rates and may allocate payments to minimize projected aggregate interest while satisfying constraints such as minimum payment requirements and user-defined budgets. The optimization may account for institution-specific payment application rules that govern how payments are distributed across sub-balances within each account.

In some embodiments, the present technology automatically detects restructuring events and regenerates payment schedules in response. Restructuring events may include acceptance of balance transfer offers, expiration of promotional interest rates, variances between actual and projected payment amounts, changes in payment allocation strategy, and adjustments to available payment amounts. The platform may detect restructuring events automatically and as such may regenerate payment schedules without requiring user-initiated recalculation.

In some embodiments, the present technology allows a user to test hypothetical scenarios in order to evaluate potential financial decisions before committing to the financial decisions. The debt consolidation platform may generate hypothetical payment schedules by applying hypothetical restructuring events to current payment schedules without modifying the underlying data. Users may explore multiple scenarios, compare hypothetical outcomes to current projections, and/or may selectively commit preferred scenarios to become active payment schedules.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Debt Consolidation Environments

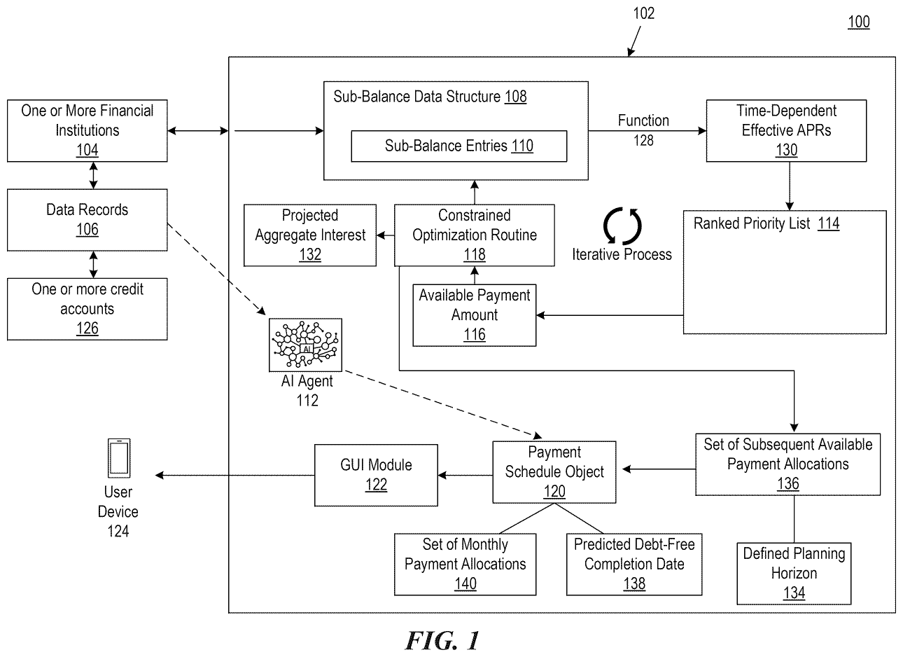

FIG. 1 illustrates an example of a debt consolidation environment 100 providing a debt consolidation platform 102. In some embodiments, the debt consolidation platform 102 communicates with or otherwise interacts with one or more financial institutions 104 and receives data records 106 from the one or more financial institutions 104. The debt consolidation platform 102 can contain a sub-balance data structure 108 including a plurality of sub-balance entries 110. Additionally or alternatively, the debt consolidation platform 102 can include an artificial intelligence (AI) agent 112, a ranked priority list 114 of the sub-balance entries 110, an available payment amount 116, a constrained optimization routine 118, a payment schedule object 120, and/or a graphical user interface (GUI) module 122. The debt consolidation environment 100 can include a user device 124, through which the debt consolidation platform 102 can cause display of various components, data structures, or GUI elements.

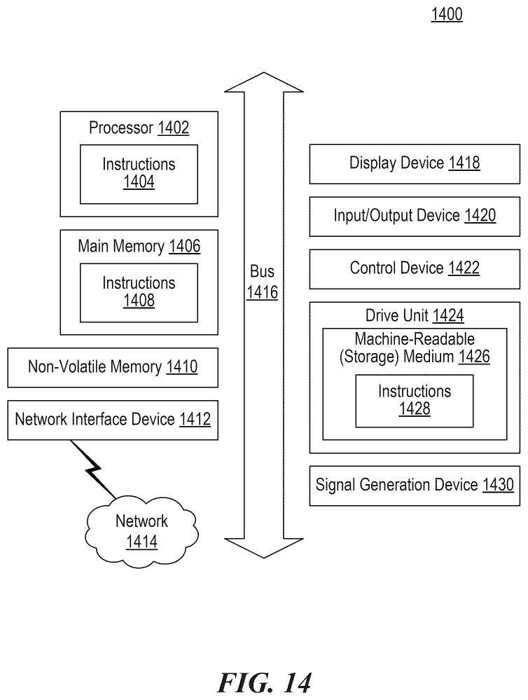

The debt consolidation environment 100 can be implemented using components of the example computer system illustrated and described in more detail with reference to FIG. 14 below. Likewise, implementations of the example debt consolidation environment 100 can include different and/or additional components or can be connected in different ways.

In some embodiments, the debt consolidation platform 102 is hosted and/or otherwise implemented by a computing device comprising a processor and a non-transitory memory storing executable instructions. In such embodiments, the computing device can be a networked computing device, such that the computing device can interact with, send data to, and/or receive data from a different computing device, such as a computer, a server, a mobile device, or another computing device. The computing device can be a mobile device, a computer, a tablet, or another computing device, and can be networked over the Internet, a local area network (LAN), a wide area network (WAN), a cellular network (e.g., 2G, 3G, 4G, 5G), a wireless network (e.g., Wi-Fi), or a wired connection (e.g., Ethernet). In some embodiments, the debt consolidation platform 102 communicates with the one or more financial institutions 104, third-party data aggregators, and/or client devices (e.g., the user device 124) via the network.

In some embodiments, the debt consolidation platform 102 ingests, by the computing device, data records 106 associated with one or more credit accounts 126 via a session with the one or more financial institutions 104. In such embodiments, the session can be an application programming interface (API) session. The API session can be established between the debt consolidation platform 102, via the computing device (e.g., one or more servers hosting the debt consolidation platform 102), and one or more servers of the one or more financial institutions 104. During the API session, the debt consolidation platform 102 can transmit requests for financial data and can receive responses including the data records 106 associated with the one or more credit accounts 126. The API session can be established using RESTful API protocols, GraphQL protocols, or other API communication standards. The data records 106 can be provided in a structured data format, such as JSON or XML, or can be provided in no such structured or standardized format to the debt consolidation platform 102.

In some embodiments, the session is an authenticated session, during which the one or more financial institutions 104 require successful authentication by the debt consolidation platform 102 before providing the data records 106. In such embodiments, the authentication requirements can significantly improve a data security of the session, such that the authentication establishes an identity of the user and/or verifies that the user has authorized the computing device to access the data records 106. In some embodiments, the authentication is established via OAuth authorization, token-based authentication, via API keys, using multi-factor authentication, or another authentication protocol or methodology.

In some embodiments, the debt consolidation platform 102 establishes a separate API session with each financial institution. In such embodiments, establishing a separate API session with each financial institution improves security of ingesting the data records 106. As such, each API session can be isolated, where a security breach or other security incident impacting one financial institution has no impact on the API sessions with other financial institutions. In some embodiments, establishing a separate API session with each financial institution causes sensitive financial data stored in the data records 106 to traverse fewer network nodes between the one or more financial institutions 104 and the debt consolidation platform 102 via the computing device, thereby reducing an exposure to interception or other unauthorized access of the data records 106.

In some embodiments, the session is a user session with the debt consolidation platform 102. The user session can begin when the user launches an application providing the debt consolidation platform 102, and can end when the user closes the application, or after a period of user inactivity. In such embodiments, the data records 106 ingested during the session can be deleted upon termination of the session. In other embodiments, the debt consolidation platform 102 securely stores the data records from the session, and subsequent data records ingested during subsequent sessions.

In some embodiments, the data records 106 include standardized transaction data records. In such embodiments, the data records 106 ingested from each financial institution includes any one or more of standardized fields, standardized file format, standardized data structures, or is otherwise standardized between each financial institution. In some embodiments, the standardized transaction data records conform to a predefined schema that normalizes data formats across multiple financial institutions. In such embodiments, the predefined schema may specify data types, field lengths, enumerated values, and validation rules for each field. The predefined schema may be defined by a third-party financial data aggregator, by the debt consolidation platform, and/or by the one or more financial institutions 104.

In some embodiments, the data records 106 are ingested from financial institutions that provide the data records in heterogeneous formats. In such embodiments, the computing device may normalize the heterogeneous formats into a common format prior to populating a sub-balance data structure 108 (e.g., upon or during ingestions of the data records 106). In some embodiments, the normalization includes mapping financial institution-specific field names to standardized field names, converting data types, parsing date formats, and/or validating data integrity.

In some embodiments, the data records 106 include fields for account identifier, sub-balance identifier, balance amount, regular annual percentage rate (APR), promotional APR, and/or promotional expiration date. Additionally or alternatively, the data records 106 may include additional fields beyond the account identifier, sub-balance identifier, balance amount, regular APR, promotional APR, and promotional expiration date. For example, the additional fields may include minimum payment amounts, transaction history, and/or payment due dates.

In some embodiments, all user data (e.g., the data records 106), including financial account information and/or credit profile data, is transmitted and/or stored using industry-standard encryption protocols (e.g., TLS 1.2+for transit and AES-256 for storage). Sensitive personally identifiable information (PII) may be stored in secure environments compliant with common financial data standards, such as System and Organization Controls (SOC) 2 Type II and, where applicable, Payment Card Industry Data Security Standard (PCI DSS).

In some embodiments, the data records 106 are encrypted locally by the debt consolidation platform 102. The local encryption can include using a zero-knowledge encryption architecture prior to storage, where encryption keys are generated locally and are not transmitted to a remote server, and/or where PII and/or financial account numbers are not transmitted in unencrypted form to the remote server.

In some embodiments, the data records 106 are received via one or more of: (i) manual user entry of account information, (ii) document upload of credit card statements, and/or (iii) optical character recognition (OCR) processing of uploaded statements. Additionally or alternatively, when certain data are not available during the API session, data may be manually input by the user to the debt consolidation platform 102. In parallel to or as an alternative to API-based data record retrieval, the user may authorize a soft credit inquiry through a credit bureau (e.g., Experian, TransUnion) or self-report credit score range, total open credit, existing credit lines and/or payment history associated with the one or more credit accounts 126.

In some embodiments, the debt consolidation platform 102 parses the data records 106 (e.g., the standardized transaction data records) to populate, in the non-transitory memory, a machine-readable sub-balance data structure 108 including a plurality of sub-balance entries 110. The sub-balance data structure 108 can be a partition aware data structure that decomposes each credit account into multiple sub-balances with independent APR parameters. As such, the sub-balance data structure 108, with a partition aware data model, provides improvements over conventional debt consolidation platforms without partition awareness, such that the debt consolidation platform 102 provides fine-grained optimization of sub-balances with independent promotional periods within a single credit account.

In some embodiments, parsing the data records 106 includes identifying, from the data records, the plurality of sub-balances associated with the one or more credit accounts 126. In such embodiments, the debt consolidation platform may extract sub-balance information from the data records 106 received from financial institutions or third-party financial data aggregators. The debt consolidation platform 102 may identify distinct sub-balances within each credit account based on a variety of parameters and/or data markers, such as a transaction type (e.g., regular purchase, balance transfer, cash advance), promotional status, and/or APR category. In some embodiments, for each identified sub-balance, the debt consolidation platform 102 extracts the balance amount, regular APR, promotional APR, and promotional expiration timestamp from the data records 106.

In some embodiments, parsing the data records 106 includes normalizing heterogeneous data formats received from different financial institutions into a common format (e.g., a standardized format), as described above. Different financial institutions may represent sub-balance information using different field names, different data types, different date formats, and/or using different data structures. As such, the computing device hosting the debt consolidation platform 102 can map institution-specific field names to standardized field names, convert data types to a common representation, parse date formats into a standardized timestamp format, and/or validate data integrity prior to populating the sub-balance data structure 108.

In some embodiments, data sources accessible to the debt consolidation platform 102, including financial data aggregator APIs, uploaded billing statements, and direct user input, provide (e.g., as the data records 106) current values for financial parameters associated with each credit account, including but not limited to minimum payment amount, statement balance, and/or accrued interest. However, data sources do not provide underlying formula parameters used by each credit card issuer (e.g., the one or more financial institutions 104) to compute minimum payment amounts. As such, formula parameters, including a minimum payment percentage, floor amount, and/or formula type, are issuer-specific and often proprietary. To enable projection of minimum payment amounts across a defined planning horizon 134, as described below and where associated balance amounts decreases over time, the processor must estimate or otherwise determine issuer-specific formula parameters from observable data (e.g., data included in the data records 106).

In some embodiments, the debt consolidation platform 102 implements estimation algorithms that accept observable data from multiple input channels. The input channels can include financial data aggregator APIs (e.g., Plaid, MX, Yodlee), direct user input via manual entry fields, AI-assisted extraction from uploaded documents, optical character recognition (OCR) of scanned billing statements, and/or parsed PDF documents, as described above. The processor can combine data from multiple input channels to estimate parameters when a single channel provides incomplete information.

In some embodiments, the processor estimates issuer-specific minimum payment formula parameters by receiving, from one or more input channels, a current minimum payment amount, a statement balance, and/or an interest amount accrued during a statement period. The process can compute an estimated minimum payment percentage by subtracting the interest amount from the minimum payment amount and dividing the result by the statement balance. In some embodiments, the processor validates a likely accuracy of the estimated minimum payment percentage against a plausibility range. The plausibility range can define an upper bound and/or a lower bound within which the estimated minimum payment percentage is considered valid. In some embodiments, the processor stores the estimated minimum payment percentage as an issuer parameter for use in projecting future minimum payment amounts and/or the set of subsequent available payment allocations 136 described below, an account balance decreases over the defined planning horizon 134. The statement balance used in the calculation can serve as a proxy for a balance basis used by the financial institution, which may differ (e.g., average daily balance) but is not exposed by data sources.

In some embodiments, the processor validates estimated parameters against subsequent billing cycles (e.g., subsequent data records received by the debt consolidation platform 102) by comparing projected minimum payment amounts to actual minimum payment amounts received from data sources. When a projection error, as determined by the validation, exceeds a threshold (e.g., one dollar, or five percent of a specific minimum payment amount), the processor can re-estimate parameters using data extracted from the subsequent data records. Over multiple billing cycles, the estimated parameters may converge toward values that accurately predict minimum payments within acceptable tolerance. Such iterative refinement compensates for any approximation error introduced by using the statement balance as a proxy for issuer-specific balance calculation methodologies. Further calculation of the parameters is described below.

In some embodiments, the sub-balance data structure 108 is implemented as an array, list, table, or other data structure stored as part of the debt consolidation platform 102. Each sub-balance entry may occupy a distinct record or element within the sub-balance data structure 108. In such embodiments, the sub-balance data structure 108 may be indexed by account identifier and/or sub-balance identifier to enable efficient retrieval of sub-balance entries 110.

In some embodiments, each sub-balance entry is implemented as a data object, record, or row, and as such, each sub-balance entry is distinct from every other sub-balance entry. Each sub-balance entry can further include distinct fields for each associated data element, such as balance amount, regular APR, promotional APR, and/or promotional expiration timestamp. The distinct fields may provide structured storage that enables the debt consolidation platform 102 to access individual values (e.g., balance amount, regular APR, promotional APR, promotional expiration timestamp) without parsing or decoding the entire sub-balance entry. In such embodiments, the distinct fields may be implemented as named properties of an object, columns of a database table, or elements of a structured data format such as JSON or XML.

In some embodiments, each sub-balance entry stores additional fields beyond the balance amount, regular APR, promotional APR, and promotional expiration timestamp. The additional fields can include an account identifier associating the sub-balance entry with a credit account, a sub-balance identifier uniquely identifying the sub-balance entry, a sub-balance type indicating a category of transactions (e.g., regular purchases, balance transfers, cash advances, promotional purchases), a minimum payment amount, a payment due date, and/or a transaction history. In such embodiments, the additional fields may enhance optimization, reporting, storage or visualization features of the debt consolidation platform 102.

In some embodiments, the promotional expiration timestamp is stored as a date value, a datetime value, or a Unix timestamp. The promotional expiration timestamp may indicate the date on or after which the promotional APR expires and the regular APR becomes effective for a sub-balance. The determination of whether the promotional APR or regular APR applies to a specific sub-balance is described further below.

In some embodiments, the debt consolidation platform 102 parses the data records into the sub-balance data structure 108 automatically upon receipt of the data records 106. Automatic parsing upon receipt may eliminate a need for a separate user-initiated parsing step, reducing latency between data ingestion and availability of sub-balance entries 110 for further processing. The debt consolidation platform 102 may proceed directly to payment schedule calculations, or visualization generation, as described further below, without waiting for manual intervention or scheduled batch processing. In some embodiments, automatic parsing enables real-time or near-real-time responsiveness of the debt consolidation platform 102 to newly received financial data (e.g., data records 106). In such embodiments, the user may experience reduced wait times when connecting financial accounts and/or refreshing account data, as the sub-balance data structure 108 is populated and ready for use immediately upon intaking the data records 106. Automatic parsing further ensures consistency of the sub-balance entries 110 stored in the sub-balance data structure 108 by applying a same parsing logic to all data records 106 without variation introduced by manual processing steps.

In some embodiments, parsing the data records 106 into the sub-balance data structure 108 standardizes data fields and/or data types of each sub-balance entry. Standardization of data fields and/or data types may improve an efficiency of processing each sub-balance entry by enabling the debt consolidation platform 102 to access data field values directly without runtime type checking, format detection, and/or data conversion. The processor then may execute optimized code paths that assume consistent data layouts, reducing branching and/or conditional logic during payment schedule calculations. Standardized data types enable use of efficient arithmetic operations, comparison operations, and/or sorting algorithms that operate on known numeric or date representations. Memory access patterns may be made more predictable when sub-balance entries 110 have uniform structure, improving cache utilization and reducing memory access latency. Standardization further reduces computational resource expenses by eliminating repeated parsing, validation, and/or conversion operations that would otherwise be required each time a sub-balance entry is accessed. As such, the debt consolidation platform 102 may allocate fewer processor cycles and/or less memory bandwidth to data handling overhead, freeing computational resources for optimization algorithms, visualization rendering, and/or GUI responsiveness.

In some embodiments, the debt consolidation platform 102 computes, for each sub-balance entry, a time-dependent effective APR for a current processing timestamp using a function 128. In such embodiments, the function 128 may assign the promotional APR as the time-dependent effective APR when the current processing timestamp precedes the promotional expiration timestamp and may assign the regular APR as the time-dependent effective APR when the current processing timestamp is on or after the promotional expiration timestamp. The time-dependent effective APR represents an actual interest rate applicable to the sub-balance at the current processing timestamp, accounting for whether a promotional period remains active or has expired.

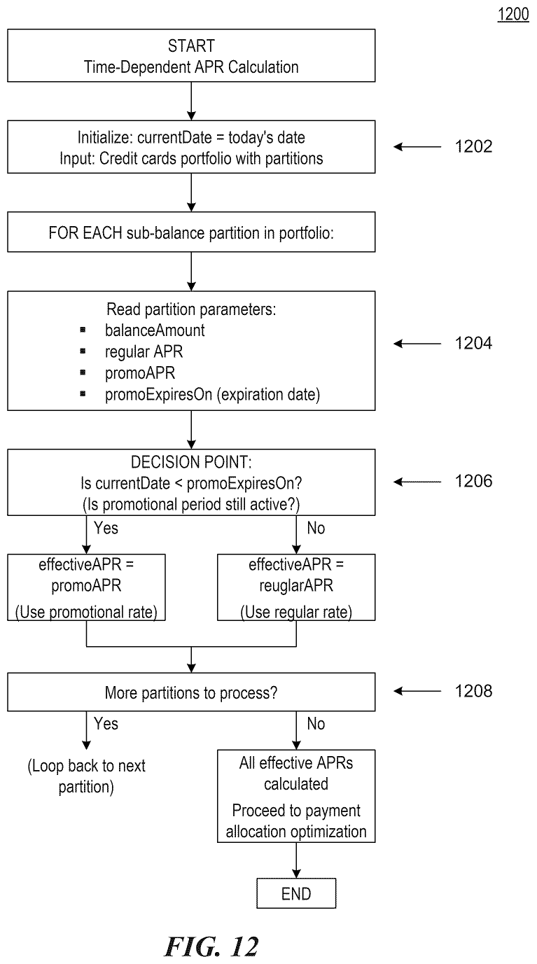

In some embodiments, the function 128 is a deterministic state function. When the function 128 is the deterministic state function, the function 128 produces the same output for the same inputs without variation or randomness. As such, given a sub-balance entry with a defined promotional APR, regular APR, and promotional expiration timestamp, and given a current processing timestamp, the deterministic state function may return a single, predictable time-dependent effective APR. The deterministic nature of the function ensures that subsequent operations of the debt consolidation platform 102 that involve the time-dependent effective APR, such as payment schedule calculations, restructuring event detection, and/or visualization generation produce consistent and otherwise reproducible results. In some embodiments, the deterministic state function enables the debt consolidation platform 102 to recalculate time-dependent effective APRs 130 at any point in time and obtain identical results for identical input conditions. An example of the function 128 for computing the time-dependent effective APRs 130 is provided in relation to FIG. 12 below.

In some embodiments, the determination of the time-dependent effective APRs 130 enables forward-looking optimization based on promotional expiration dates, rather than reactive adjustment after expiration of promotional APRs. The debt consolidation platform 102 may identify sub-balances with promotional APRs expiring within a predetermined threshold period (e.g., within a day, within a week, within one month, within two months, within three months, within six months) and may calculate a projected aggregated interest if the sub-balance is not paid off before the promotional expiration date. Such a forward-looking capability allows the debt consolidation platform 102 to prioritize payment allocation to sub-balances approaching promotional expiration, even if another sub-balance currently has a higher effective APR. An example of an optimization routine is described further, below.

In some embodiments, the processor generates a ranked priority list 114 of the sub-balance entries 110 by sorting the sub-balance entries 110 according to the computed time-dependent effective APRs 130. The ranked priority list 114 may order sub-balance entries 110 from a highest time-dependent effective APR to a lowest time-dependent effective APR. In some embodiments, the sub-balance entries 110 appearing earlier in the ranked priority list 114 receive payment allocation priority over the sub-balance entries 110 appearing later in the ranked priority list 114. As such, the ranked priority list 114 may provide an indication to the debt consolidation platform 102 of the sub-balance entries 110 that should receive a higher priority when allocating an available payment amount 116.

In some embodiments, ties between time-dependent effective APRs 130 are broken using a predefined rule. The predefined rule can favor sub-balance entries 110 with larger balance amounts or sub-balance entries 110 with smaller balance amounts being ranked higher in the ranked priority list 114. For example, when two or more sub-balance entries have identical time-dependent effective APRs, the processor may order the tied sub-balance entries by a balance amount associated with each tied sub-balance entry in descending order, such that a sub-balance entry with a larger balance amount is ranked higher in priority than a sub-balance entry with a smaller balance amount among the tied sub-balance entries. Favoring larger balance amounts among tied sub-balance entries may maximize interest savings by directing payments (e.g., the available payment amount 116) to the sub-balance that accrues the greatest absolute interest amount at the tied time-dependent effective APR.

In some embodiments, the processor implements the sorting of the sub-balance entries 110 using a comparison-based sorting algorithm such as quicksort, mergesort, or heapsort. The algorithm may first compare the time-dependent effective APRs 130 of two sub-balance entries. If the time-dependent effective APRs 130 are equal, the algorithm may then compare the balance amounts of the two sub-balance entries. In some embodiments, the sorting algorithm applies the comparison function iteratively to produce the ranked priority list 114.

In some embodiments, the ranked priority list 114 is stored in the non-transitory memory as an ordered array, linked list, or priority queue data structure. The ranked priority list 114 may maintain references or pointers to the sub-balance entries 110 in the sub-balance data structure 108, preserving the sorted order of sub-balance entries 110 for subsequent access by a payment allocation optimizer module, or other modules of the debt consolidation platform 102.

In some embodiments, the processor regenerates the ranked priority list 114 when the sub-balance data structure 108 is updated. Updates to balance amounts, promotional APRs, regular APRs, or promotional expiration timestamps may change the computed time-dependent effective APRs 130 and/or a relative ordering of sub-balance entries 110. In such embodiments, the processor may re-sort the sub-balance entries 110 to produce an updated ranked priority list reflecting a current state of the sub-balance data structure 108. In some embodiments, the processor performs such a regeneration automatically, without any intervention or prompting from the user.

In some embodiments, the predefined rule for breaking ties comprises an alternative or additional criterion beyond balance amount. The alternative criterion may include sub-balance type (e.g., prioritizing cash advances over balance transfers over regular purchases), promotional expiration timestamp (e.g., prioritizing sub-balances with earlier expiration dates), account identifier (e.g., prioritizing sub-balances from a particular financial institution), or a different, user-defined priority. In such embodiments, the predefined rule may include a hierarchy of tie-breaking criteria applied in sequence until the tie between the sub-balance entries 110 is resolved. In some embodiments, the predefined rule for breaking ties favors smaller balance amounts, such that a sub-balance entry with a smaller balance amount is ranked higher in priority than a sub-balance entry with a larger balance amount among the tied sub-balance entries.

In some embodiments, the ranked priority list 114 excludes sub-balance entries 110 with zero balance amounts, such that sub-balance entries 110 that have been fully paid off and do not require payment allocation are omitted from the ranked priority list 114. The processor may filter the sub-balance entries 110 prior to or during sorting to exclude zero-balance entries from the ranked priority list 114.

In some embodiments, excluding zero-balance entries reduces a number of elements processed by the sorting algorithm, thereby decreasing a computational complexity of generating the ranked priority list 114. In such embodiments, the sorting algorithm may perform fewer comparisons and fewer memory operations when operating on a reduced set of sub-balance entries. Excluding zero-balance entries may also reduce a size of the ranked priority list 114 stored in the non-transitory memory, decreasing memory consumption and improving cache efficiency during subsequent access by the payment allocation optimizer module, or other modules of the debt consolidation platform 102. The payment allocation optimizer module therefore iterates over fewer entries when allocating available payment amounts, reducing processor cycles expended on entries that cannot receive meaningful payment allocation. In some embodiments, excluding zero-balance entries eliminates unnecessary computation during recalculation of time-dependent effective APRs 130, as the processor does not compute the time-dependent effective APRs 130 for sub-balance entries 110 that have no remaining balance.

In some embodiments, the processor allocates the available payment amount 116 to sub-balance entries 110 according to the ranked priority list 114 using a constrained optimization routine 118 that minimizes projected aggregate interest 132 subject to defined constraints. The available payment amount 116 may represent a total amount of funds the user designates for debt repayment during a billing cycle or payment period (e.g., in a month). In some embodiments, the constrained optimization routine 118 distributes the available payment amount 116 across one or more sub-balance entries in a manner that reduces total interest accrued across all sub-balance entries 110 while satisfying the defined constraints.

In some embodiments, the constrained optimization routine 118 allocates the available payment amount 116 by traversing the ranked priority list 114 in order from highest priority to lowest priority. As such, the processor may allocate funds (e.g., some or all of the available payment amount 116) to the highest-ranked sub-balance entry first, then proceeds to the next-highest-ranked sub-balance entry, continuing until the available payment amount 116 is exhausted or all sub-balance entries 110 have received allocation. Allocating according to the ranked priority list 114 may more efficiently direct payments to sub-balance entries 110 with the highest time-dependent effective APRs, which accrue interest at a fastest rate, thereby minimizing projected aggregate interest 132.

In some embodiments, the defined constraints comprise minimum payment rules per account. Each credit account may have a minimum payment amount, for example, as set by the financial institution providing the credit account, which must be paid during each billing cycle to avoid late fees, penalty APRs, and/or negative credit reporting. In some embodiments, the constrained optimization routine 118 first allocates the minimum payment amount to each credit account before allocating excess funds to sub-balance entries 110 according to the ranked priority list. The processor determines the minimum payment amount for each credit account from the data records 106 or from user input.

In some embodiments, the defined constraints comprise institution-specific payment application rules. Different financial institutions may apply payments to sub-balances within a credit account according to different rules. Some financial institutions may apply payments to a sub-balance with a lowest-APR first, while other financial institutions may apply payments to a sub-balance with a highest-APR first, and still other financial institutions may apply payments proportionally across sub-balances. As such, in some embodiments, the constrained optimization routine 118 accounts for institution-specific payment application rules when determining how to allocate the available payment amount 116 to sub-balances within each credit account. The processor retrieves institution-specific payment application rules from the data records 106, from a rules database, or from user input.

In some embodiments, when calculating minimum payment amounts, minimum payment formula types incorporate a floor amount. The floor amount can be a minimum dollar threshold that applies to the minimum payment amount regardless of the percentage calculation, as described above. When a minimum payment amount calculated based on a minimum payment percentage falls below the floor amount, the floor amount may control and become the minimum payment amount. As such, the floor is not a separate formula type but rather a component of all formula types that can bind or otherwise control when a balance is sufficiently low. Common floor values used by financial institutions include twenty-five dollars, thirty-five dollars, and forty dollars, however, any floor amount may be used by the debt consolidation platform 102 when calculating the minimum payment amount.

In some embodiments, the processor detects the floor amount using a two-step process. In a first step, the processor can compare an observed minimum payment to a set of common floor amounts used by financial institutions, including twenty-five dollars, thirty-five dollars, and/or forty dollars. When the observed minimum payment equals one of these common floor amounts, the processor can determine, with high confidence, that the floor amount is binding, because a percentage-based calculation, as described above, resulting in an exact, round dollar amount is very unlikely. When the observed minimum payment amount both matches a common floor amount and exceeds the calculated percentage-based minimum payment amount, the processor can assign high confidence that the floor amount is accurately estimated.

In a second step, when the observed minimum payment amount does not match a common floor amount, the processor can compare the observed minimum payment amount to a calculated percentage-based minimum payment amount computed using a maximum expected minimum payment percentage (e.g., three percent). When the observed minimum payment amount exceeds the calculated percentage-based minimum payment amount even at the maximum percentage, the processor can determine that the floor amount is binding and can store the observed minimum payment amount as the floor amount with medium confidence, such that the credit account is flagged for validation over subsequent billing cycles. In some embodiments, floor amounts that do not match common floor amounts are assigned medium confidence because the floor amount can represent an issuer-specific amount not included in the set of common floor amounts or can otherwise indicate a data quality issue requiring additional validation.

In some embodiments, over multiple billing cycles in which the one or more credit accounts have varying associated balance amounts, the processor can collect data that simultaneously enables estimation of both the floor amount and the minimum payment percentage. The processor can store estimated floors and estimated percentages in association with a corresponding credit account and/or corresponding sub-balance entry in the sub-balance data structure for use in projecting future minimum payment amounts across the defined planning horizon 134. In some embodiments, the processor identifies a minimum payment amount formula type, which can be specific to any one or more of the financial institutions, by fitting observable data to a plurality of known formula structures. For example, the two primary formula structures used by the one or more financial institutions 104 are: (a) a flat percentage formula where the minimum payment amount equals the greater of a floor amount or a percentage of a total balance amount, with interest included in the percentage calculation, and (b) a percentage-plus-interest formula where a percentage of a principal balance is computed and interest and fees are added separately. The flat percentage formula is most commonly used by credit unions and subprime issuers, which are examples of the one or more financial institutions 104. The percentage-plus-interest formula is used by most large credit card issuers, which serve as another example of the one or more financial institutions 104.

In some embodiments, the processor determines an applicable formula type of the minimum payment amount formula types by computing a fitting error for each formula type using candidate percentage and/or floor values. For example, during each billing cycle (e.g., once per month), the processor can calculate an expected minimum payment amount under both the flat percentage formula and the percentage-plus-interest formula using an observed statement balance amount, an interest amount, and/or a fee amount. In some embodiments, the processor compares a calculated expected minimum payment amount determined under each formula to the actual observed minimum payment amount, and records a fitting error for each formula type. In such embodiments, the processor can select the formula type that produces a lowest cumulative fitting error across multiple billing cycles. A number of the multiple billing cycles can be determined by the debt consolidation platform 102, and can be any number of billing cycles. For example, the number of billing cycles can be two, three, six, twelve, twenty-four, or any other number of billing cycles. When neither formula type fits within an acceptable tolerance, and sub-balance data is available, the processor can attempt to fit a generalized per-sub-balance formula, as described further below.

The formula used by the debt consolidation platform 102 to calculate the minimum payment amount can be as follows,

minimum_payment=MIN(total_balance,MAX(floor,(pct×balance_before_interest)+new_interest+

[symbol]

wherein the derived parameters are floor and pct. In some embodiments, the processor applies the formula type associated with the lowest cumulative fitting error to project future minimum payment amounts across the defined planning horizon 134. For each period (e.g., each monthly period) in the defined planning horizon 134, the processor can apply the identified formula type to a projected balance amount associated with that period, projected interest amount, and/or projected fee amounts for that period. As the balance amount decreases over the defined planning horizon 134 due to payment allocations, the projected minimum payment amount likewise can decrease when the percentage-based calculation exceeds the floor amount, and can otherwise remain at the floor amount when the percentage-based calculation falls below the floor amount. As such, the projected minimum payment amounts enable the constrained optimization routine 118 to determine the portion of the available payment amount 116 consumed by minimum payment requirements at each monthly period and to subsequently allocate an excess payment amount to sub-balance entries 110 according to the ranked priority list 114.

In some embodiments, identifying the formula type improves computational efficiency of the debt consolidation platform 102 by enabling the processor to apply a single, validated formula type to all future projections for a given credit account rather than computing projections under multiple candidate formulas at each period (e.g., monthly). Once the formula type associated with the lowest cumulative fitting error is identified and stored in association with the credit account, the processor can retrieve the stored formula type and utilize the stored formula type during each iteration of the constrained optimization routine 118. As such, the processor can avoid recomputing fitting errors across multiple formula types at each period, reducing a number of operations performed during payment schedule object 120 generation. The identified formula type can be re-evaluated when validation against actual data indicates that the formula type no longer fits within acceptable tolerance.

In some embodiments, identifying the formula type further improves the debt consolidation platform by enabling accurate forward projection of minimum payment amounts. Conventional systems can receive a current minimum payment amount from a financial data aggregator but cannot project how the minimum payment amount will change or otherwise evolve as balances decrease over time. Without an identified formula type, conventional systems often assume a static minimum payment amount or apply a generic estimation that does not reflect actual calculations performed by the one or more financial institutions 104. Identifying the formula type allows the debt consolidation platform to project minimum payment amounts more accurately, and therefore, determine a set of subsequent available payment allocations 136 that reflect a financial institution's actual calculation methodology, producing more accurate subsequent payment allocations, a more accurate predicted debt-free completion date, and/or a more accurate projected aggregate interest across the defined planning horizon 134 than conventional systems that do not identify the formula type associated with the lowest cumulative fitting error.

In some embodiments, the minimum payment amount formula applies different percentages to different sub-balances within a single credit account. For example, the one or more financial institutions 104 can apply more than one minimum payment amount formula when different formulas apply to different features of an account, such as general revolving balances versus special purchase plans. As such, the generalized per-sub-balance formula can compute a separate percentage-based amount for each sub-balance, add an amount of interest accrued on each sub-balance, add any applicable fees, and compare a resulting sum to the floor amount. In some embodiments, the greater of the floor amount or the resulting sum, plus any past due amount, becomes the minimum payment amount. In such embodiments, a total minimum payment amount can be capped at a total balance amount to prevent overpayment.

In some embodiments, the formula used by the debt consolidation platform 102 when there are multiple sub-balance types within a credit account is as follows,

$${minimum}_{payment} = MIN ( {total}_{balance} , MAX \{ floor , {\sum }_{i} ( ( {pct}_{i} \times {balance}_{{i}_{{before}_{interest}}} ) + {interest}_{i} ) + fees ) + {past}_{due} )$$

where the derived parameters include floor, and pct_i for each sub-balance type.

Further defining variables used in the equation provided here and above,

balance_before_interest=current_balance−new_interest; ∧new_interest=Σᵢ(balance_i×((1

[symbol]

for the formula provided with regard to multiple sub-balance types, balance_before_interest for each sub-balance can be defined as the current balance minus new interest accrued during the billing period, and new interest can be computed using daily compounding formula

interest_i=balance_i×((1+APR_i/365)∧days−1)

where days is the number of days in the billing cycle.

With continued reference to the multiple sub-balance type formula, the partition-aware sub-balance tracking can enable tractable parameter derivation. To compute new_interest accurately, the processor can require sub-balance-level data because different sub-balance types carry different APRs that can produce different interest amounts for the same balance. Without sub-balance visibility, the interest component confounds the percentage estimation, and the processor cannot separate the percentage coefficients when interest from mixed APRs is aggregated at the account level. As such, many account-level-only systems cannot perform this derivation. Because the system tracks sub-balances with their respective amounts and APRs, the processor can observe minimum payments across multiple billing cycles where the sub-balance mix varies. This creates a system of linear equations solvable for the percentage coefficients via least squares regression. In some embodiments, the floor is identified when the minimum payment remains constant despite changing balances, indicating the MAX function is returning the floor value rather than the calculated amount.

In some embodiments, the processor estimates per-sub-balance percentages by analyzing minimum payment amounts across multiple billing cycles in which sub-balance compositions vary. The debt consolidation platform 102 can enable tractable parameter derivation. To compute interest accurately, the processor can require partition-level (e.g., sub-balance level) data because different sub-balances or different sub-balance types can carry different APRs that in turn can produce different interest amounts for a same sub-balance. Without sub-balance granularity, an interest component can confound the percentage estimation such that the processor cannot separate the percentage coefficients when interest from mixed APRs is aggregated at the credit account level rather than the sub-balance level. For these and other reasons, account-level-only conventional systems cannot perform the parameter derivation of the debt consolidation platform 102.

In some embodiments, because the system tracks sub-balances with respective amounts and APRs, the processor observes minimum payment amounts across multiple billing cycles where the sub-balance mix varies. Each billing cycle can thus provide a linearly independent equation relating an observed minimum payment amount to sub-balance amounts and unknown percentage coefficients. Deriving per-sub-balance percentages can require at least N billing statements for an account with N active sub-balance types. When the number of statements equals or exceeds the number of active sub-balance types, the processor can then solve a system of equations using least-squares regression to estimate the percentage coefficient associated with each sub-balance type. As such, for accounts with a single balance type, a single billing statement can be sufficient to estimate the percentage coefficient.

In some embodiments, the per-sub-balance formula improves computational efficiency of the debt consolidation platform 102 by enabling the processor to project minimum payment amounts at the sub-balance level rather than the account level. The processor can calculate a contribution of each sub-balance type to the total minimum payment independently, using the estimated percentage coefficient and/or the projected balance for each sub-balance type at each period. As individual sub-balances are paid off over the defined planning horizon 134, the processor can remove a contribution of the sub-balances with zero balance from the minimum payment calculation without re-estimating the percentage coefficients for the remaining sub-balances. As such, the sub-balance-level computation can avoid forcing the debt consolidation platform 102 to recompute the entire minimum payment estimation each time a sub-balance reaches zero, reducing computational resource expense during payment schedule object 120 generation.

In some embodiments, the per-sub-balance formula improves the debt consolidation platform by enabling more accurate projection of minimum payment amounts for credit accounts with multiple sub-balance types carrying different APRs and/or different percentage coefficients. The sub-balance level projection incorporates that as higher-APR sub-balances are paid off, an interest component of the minimum payment amount can decrease at a different rate than when lower-APR sub-balances are paid off. As such, the per-sub-balance formula captures the differential effects, producing projected minimum payment amounts that more accurately reflect a financial institution's actual calculation. The improved accuracy of projected minimum payment amounts can propagate through the constrained optimization routine 118, producing more accurate payment allocations, a more accurate predicted debt-free completion date, and/or a more accurate projected aggregate interest across the defined planning horizon 134 than conventional systems.

In some embodiments, the defined constraints include a user-defined monthly budget. In such embodiments, the user may specify a maximum amount available (e.g., the available payment amount 116) for debt repayment during each billing cycle based on income, expenses, and/or financial goals. The constrained optimization routine 118 may avoid allocating more than the user-defined monthly budget, even if additional allocation would further reduce projected aggregate interest 132. In some embodiments, the debt consolidation platform 102 receives the user-defined monthly budget via the GUI module 122 or another user input interface of the debt consolidation platform 102.

In some embodiments, the constrained optimization routine 118 calculates projected aggregate interest 132 by summing projected interest accrual across all sub-balance entries 110 over a defined planning horizon 134. For each sub-balance entry, the processor may calculate projected interest based on the balance amount, the time-dependent effective APR, and/or the available payment amount 116. The constrained optimization routine 118 may then iteratively adjust payment allocation to minimize the sum of projected interest across all sub-balance entries 110 while satisfying the defined constraints. In some embodiments, the constrained optimization routine is implemented using linear programming, a greedy algorithm, dynamic programming, or another programming/optimization routine.

In some embodiments, the available payment amount 116 is less than a sum of the minimum payment amounts required by each credit account. As such, the constrained optimization routine 118 may detect that the defined constraints cannot be fully satisfied with the available payment amount 116. In such embodiments, the processor may generate an alert or notification to the user via the GUI module 122 indicating that the available payment amount 116 is insufficient to meet all minimum payment requirements. In some embodiments, the alert identifies a shortfall amount representing a difference between the sum of minimum payment amounts and the available payment amount 116.

In some embodiments, when the available payment amount 116 is insufficient to meet all minimum payment requirements, the constrained optimization routine 118 allocates the available payment amount 116 according to a prioritization scheme. The prioritization scheme may allocate minimum payments to credit accounts in order of consequence severity, prioritizing accounts with higher penalty APRs, higher late fees, or greater negative credit reporting impact. The processor may retrieve consequence severity information from the data records 106, from a rules database, or from user input.

In some embodiments, when the available payment amount 116 is insufficient to meet all minimum payment requirements, the constrained optimization routine 118 allocates the available payment amount 116 proportionally across the one or more credit accounts 126. The processor may calculate a proportional share for each credit account based on the ratio of the credit account's minimum payment amount to the sum of all minimum payment amounts. Then, each credit account may receive the proportional share of the available payment amount 116, resulting in partial minimum payments across all credit accounts.

In some embodiments, when the available payment amount 116 is insufficient to meet all minimum payment requirements, the constrained optimization routine 118 presents allocation options to the user via the GUI module 122. The user may provide a selection of the credit accounts that should receive the minimum payment allocation, and which credit accounts should receive reduced or no allocation. In some embodiments, the processor allocates the available payment amount 116 according to the user's selection.

In some embodiments, the constrained optimization routine 118 implements a mixed-integer linear programming (MILP) formulation to determine optimal payment allocations across the plurality of sub-balance entries 110 over the defined planning horizon 134. The MILP formulation defines continuous decision variables representing payment allocation amounts for each sub-balance entry in each monthly period across the defined planning horizon 134, and binary decision variables representing whether a deferred-interest sub-balance entry is fully paid off before its promotional expiration timestamp. The objective function can minimize the projected aggregate interest 132 computed as the sum, across all sub-balance entries and all monthly periods, of the product of each sub-balance entry's remaining balance and its time-dependent effective APR. In some embodiments, the MILP formulation is subject to constraints including: (a) the sum of all payment allocations in each monthly period does not exceed the available payment amount 116; (b) each credit account receives at least its minimum payment amount in each period; (c) institution-specific payment application rules governing within-account allocation across sub-balances; and (d) payment allocations are non-negative. In some embodiments, the processor selectively invokes the MILP formulation when the sub-balance data structure 108 contains one or more sub-balance entries with deferred-interest promotional terms and applies the ranked priority list 114 with greedy allocation when no such deferred-interest sub-balance entries are present.

In some embodiments, the binary decision variables in the MILP formulation model deferred-interest cliff events. A deferred-interest cliff event can occur when a promotional APR of zero percent applies to a sub-balance entry during a promotional period, and upon expiration of the promotional period, interest accrued retroactively over the entire promotional period becomes due when the sub-balance is not paid in full before the promotional expiration timestamp. As such, and for each such sub-balance entry, the MILP formulation can define a binary variable indicating whether the sub-balance entry achieves a zero balance at or before the promotional expiration month. The processor enforces this relationship using a linearization constraint of the form: remaining balance at the promotional expiration month is less than or equal to a scaling constant multiplied by one minus the binary variable, where the scaling constant equals the original balance of the sub-balance entry. When the binary variable equals one, the constraint forces the remaining balance to zero, indicating the sub-balance is paid off and the retroactive interest penalty is avoided. When the binary variable equals zero, the remaining balance is unconstrained, and the retroactive interest penalty can be included in the objective function. In some embodiments, the MILP solver evaluates whether the interest savings from avoiding each deferred-interest penalty justifies the opportunity cost of diverting payment amounts from other sub-balance entries with higher time-dependent effective APRs.

In some embodiments, the MILP formulation creates decision variables for every combination of credit account, sub-balance entry, and monthly period across the entire planning horizon, and solves all monthly periods simultaneously rather than sequentially. The processor can generate all constraints, including budget constraints, minimum payment constraints, balance dynamics constraints, and deferred-interest cliff constraints for all monthly periods before invoking the solver. The solver can return a globally optimal allocation schedule for every monthly period in a single computation. This full-horizon simultaneous approach enables the solver to evaluate tradeoffs that span multiple months, such as whether to allocate payments to a sub-balance entry carrying a zero-percent promotional APR to avoid a future deferred-interest penalty versus allocating payments to a different sub-balance entry currently accruing interest at a higher time-dependent effective APR. The partition-aware sub-balance data structure enables the MILP formulation to optimize at a granularity not achievable by account-level optimization systems, because different sub-balances within a single credit account carry different time-dependent effective APRs, different promotional expiration timestamps, and different deferred-interest terms.

In some embodiments, when the available payment amount 116 is insufficient to meet all minimum payment requirements, the processor calculates and displays projected consequences of the shortfall. The projected consequences include estimated late fees per account, estimated penalty APR increases, estimated negative credit score impact, and/or estimated additional interest accrued due to unpaid balances. Display of the projected consequences provides the user with improved information to make informed decisions about payment allocation and/or to adjust the available payment amount 116. In some embodiments, when the available payment amount 116 is insufficient to meet all minimum payment requirements, the processor recommends adjustments to the user-defined monthly budget (e.g., the available payment amount 116). In such embodiments, the processor may calculate the minimum available payment amount required to satisfy all minimum payment requirements and may present the calculated amount to the user as a recommended budget adjustment. The user then may accept the recommended adjustment or maintain the available payment amount 116 with awareness of consequences.

In some embodiments, the debt consolidation platform 102 updates, after each allocation, the sub-balance data structure 108 by writing back reduced balance amounts. The processor may calculate a reduced balance amount for each sub-balance entry by subtracting the allocated payment amount from a current balance amount stored in the sub-balance entry. The processor may also write the reduced balance amount to the balance amount field of the sub-balance entry in the sub-balance data structure 108 stored in the non-transitory memory. In some embodiments, writing back reduced balance amounts after each allocation of the available payment amount 116 ensures that the sub-balance data structure 108 reflects a current state of the user's debt following each payment allocation.

In some embodiments, the processor records an allocation log entry (e.g., in an allocation log) after each allocation. The allocation log entry may include a timestamp, an allocated amount, and/or a resulting balance per sub-balance entry. In some embodiments, the timestamp indicates the date and time at which the allocation is performed. Further, the allocated amount may indicate the payment amount directed to each sub-balance entry during the allocation. Additionally or alternatively, the resulting balance may indicate the balance amount remaining in each sub-balance entry after the allocated amount is subtracted.

In some embodiments, the allocation log is stored in the non-transitory memory as a sequential data structure such as an array, list, or table. Each allocation log entry may thus be appended to the allocation log after each allocation cycle. In some embodiments, the allocation log accumulates a history of allocations over the planning horizon, providing a complete record of payment allocations and balance reductions.

In some embodiments, the allocation log entry includes additional fields beyond the timestamp, allocated amount, and resulting balance. The additional fields may include an account identifier associating the allocation with a credit account, a sub-balance identifier associating the allocation with a sub-balance entry, the time-dependent effective APR at the time of allocation, the interest accrued during the allocation period, and/or a cumulative interest paid amount. In such embodiments, by including the additional field in the allocation log, the debt consolidation platform 102 may provide enhanced reporting, auditing, or visualization of the sub-balance information.

In some embodiments, recording the allocation log improves the debt consolidation platform 102 by providing an audit trail of payment allocations. The user may review the allocation log via the GUI module 122 on the user device 124 to verify that allocations are performed as expected. The allocation log also allows the user to identify discrepancies between planned allocations and actual payments made to the one or more financial institutions 104.

In some embodiments, the allocation log is synchronized with a remote server for backup and/or cross-device access. The processor may transmit allocation log entries to the remote server when network connectivity is available. The user may then access the allocation log from multiple devices by retrieving the allocation log from the remote server. In such embodiments, the allocation log may be encrypted prior to transmission to protect sensitive financial data (e.g., PII).

In some embodiments, the constrained optimization routine 118 implements an optimization strategy focused on sub-balance entries 110 with lower balance amounts. Such an optimization strategy can be referred to as “snowball” optimization, and an alternative optimization strategy, such as a strategy that focuses on, or otherwise prioritizes sub-balance entries 110 with higher balance amounts, can be referred to as “avalanche” optimization. The snowball optimization strategy can target sub-balance entries by balance amount (e.g., by prioritizing sub-balance entries 110 with lower balance amounts) rather than other factors such as APR.

In some embodiments, the processor sorts the plurality of sub-balance entries 110 by ascending balance amount, such that a sub-balance entry with a smaller balance amount is ranked higher in priority than a second sub-balance entry with a larger balance amount. Such sorting can prioritize elimination of individual sub-balance entries (e.g., when a sub-balance entry has a “zero” balance), over a mathematical minimization of projected aggregate interest 132.

In some embodiments, when two or more sub-balance entries have equal balance amounts, the processor applies a predefined tie-breaker rule. In such embodiments, the tie-breaker can favor higher effective interest rates, such that among sub-balance entries 110 with equal balance amounts, a sub-balance entry with a higher effective APR can be ranked higher in priority than a sub-balance entry with a lower effective APR. In some embodiments, the tie-breaker preserves insertion order (e.g., stable sort). In some embodiments, the tie-breaker applies alternative criteria, as described above.

In some embodiments, after sorting the sub-balance entries 110 according to the snowball optimization strategy described above, the processor allocates the available payment amount 116. In such embodiments, the processor can allocate the available payment amount 116 according to a defined sequence, such as: (a) allocate, to each sub-balance entry or credit account, an associated minimum required payment amount, (b) compute an excess amount equal to available payment amount 116 minus a sum of the associated minimum payment amounts, and, when the excess amount is greater than zero, (c) allocate the excess amount to sub-balance entries 110 and/or credit accounts in a priority order defined by the snowball optimization (e.g., to a sub-balance entry with a lowest balance first) until the excess amount is exhausted or all sub-balance amounts are paid in full (e.g., have a zero balance amount).

In some embodiments, within each credit account, the processor models payment allocation across sub-balance entries 110 using a configurable allocation rule that defaults to allocating minimum payments to lowest-APR sub-balance entries first and excess payments to highest-APR sub-balance entries first. The example of payment allocation provided above is purely exemplary; the processor can utilize any alternative payment allocation strategy, including user-specified payment allocation strategies. In some embodiments, the snowball optimization strategy described above applies at the credit account level, rather than the sub-balance level, such that the snowball optimization strategy determines which credit account receives excess payment amounts (e.g., lowest balance credit accounts), rather than which sub-balance entry receives excess payment amounts. In such embodiments, the allocation strategy described above, where a highest APR sub-balance entry within a credit account receives the excess payment amount first, can apply.

The snowball optimization described above can result in higher projected aggregate interest paid, by the user, as compared to alternative strategies such as avalanche optimization. However, the debt consolidation platform 102 can present multiple strategies (e.g., snowball optimization, avalanche optimization) to the user alongside projected aggregate interest 132 associated with each strategy, and/or defined planning horizon 134 associated with each strategy, providing improved display of complex financial information to the user. Further, the debt consolidation platform 102 can more effectively calculate and project future payment timelines for the user based on the parameter derivation of the debt consolidation platform 102, compared to conventional systems which often lack an ability to derive parameters related to minimum payment amounts.

In some embodiments, the processor recalculates the time-dependent effective APRs 130 for the updated sub-balance entries. After updating the sub-balance data structure 108 with reduced balance amounts following an allocation, the processor recomputes the time-dependent effective APR (e.g., by the function 128) for each sub-balance entry based on the current processing timestamp. The recalculation determines whether the current processing timestamp has crossed any promotional expiration timestamps associated with any sub-balance entry since the previous calculation. In some embodiments., for sub-balance entries 110 where the current processing timestamp now equals or exceeds the promotional expiration timestamp, the function 128 assigns the regular APR, instead of the promotional APR, as the time-dependent effective APR. Recalculating the time-dependent effective APRs ensures that the ranked priority list 114 reflects current effective interest rates rather than outdated values from prior allocation cycles.

In some embodiments, the time-dependent effective APRs 130 are recalculated at a set cadence. The set cadence may define a recurring time interval at which the processor automatically recalculates the time-dependent effective APR for each sub-balance entry in the sub-balance data structure 108. The processor initiates recalculation upon expiration of each interval without requiring user action to trigger the recalculation.

In some embodiments, the set cadence is daily. The processor recalculates the time-dependent effective APRs once per day at a predetermined time. Daily recalculation enables the debt consolidation platform to detect promotional expiration timestamps that occur on any day of the month and to update the sub-balance data structure 108 promptly following the expiration.

In some embodiments, the set cadence is weekly. The processor recalculates the time-dependent effective APRs once per week on a predetermined day. Weekly recalculation balances responsiveness to changes in time-dependent effective APRs 130 with reduced computational resource consumption compared to daily recalculation.

In some embodiments, the set cadence is monthly. The processor recalculates the time-dependent effective APRs once per month at a predetermined date, such as the first day of the month or the date corresponding to the user's billing cycle. Monthly recalculation aligns with typical payment cycles of financial institutions, which issue statements and require minimum payments on a monthly basis. Aligning the recalculation cadence with financial institution payment cycles may ensure that the sub-balance data structure 108 reflects time-dependent effective APRs 130 applicable to each billing period. Monthly recalculation may further reduce computational resource expense by performing recalculation twelve times per year rather than fifty-two times per year for weekly recalculation or three hundred sixty-five times per year for daily recalculation.

In some embodiments, the set cadence is longer than monthly, such as yearly. Yearly recalculation may be suitable for sub-balance entries 110 with promotional periods spanning multiple years or for users with stable debt portfolios requiring infrequent updates.

In some embodiments, the set cadence is configurable by the user. The user may specify the recalculation cadence via the GUI module 122 by selecting from available options such as daily, weekly, monthly, or yearly. The processor may store the user-specified cadence and automatically initiates recalculation according to the selected interval. In such embodiments, the user may select a more frequent cadence for active debt management or a less frequent cadence to conserve computational resources.

In some embodiments, the set cadence is determined automatically by the debt consolidation platform 102 based on characteristics of the sub-balance data structure 108. For example, the processor may analyze the promotional expiration timestamps across all sub-balance entries and selects a cadence that ensures recalculation occurs prior to each promotional expiration. In such embodiments, the processor may select a more frequent cadence when multiple promotional expirations are approaching or a less frequent cadence when no promotional expirations are imminent.

In some embodiments, the processor performs recalculation at the set cadence in addition to event-triggered recalculation. As such, the set cadence ensures periodic recalculation even when no restructuring events are detected, while event-triggered recalculation provides immediate responsiveness to detected changes. The combination of cadence-based and event-triggered recalculation ensures that the sub-balance data structure 108 and associated elements of the debt consolidation platform 102 remain current under both stable and dynamic debt conditions.

In some embodiments, the processor repeats the constrained optimization routine 118 after recalculating the time-dependent effective APRs 130. The processor may regenerate the ranked priority list 114 by sorting the updated sub-balance entries according to the recalculated time-dependent effective APRs. The processor allocates the available payment amount for the next allocation cycle, which may be the same as the available payment amount 116, according to the regenerated ranked priority list using the constrained optimization routine 118. Repeating the constrained optimization routine 118 after each recalculation ensures that payment allocations adapt to changes in time-dependent effective APRs 130 as promotional periods expire.

In some embodiments, the processor produces a set of subsequent available payment allocations 136 over a defined planning horizon 134 of N monthly periods. In such embodiments, the defined planning horizon 134 may represent a number of future monthly periods for which the processor projects payment allocations. Additionally or alternatively, the processor may iteratively perform recalculation of the time-dependent effective APRs 130, regeneration of the ranked priority list 114, and/or execution of the constrained optimization routine 118 for each of the N monthly periods. Each iteration advances the current processing timestamp by one monthly period and processes the allocation for that period.

In some embodiments, the processor projects the available payment amount 116 for each of the N monthly periods based on the user-defined monthly budget. The processor may assume that the user-defined monthly budget remains constant across the defined planning horizon 134 unless the user specifies variable payment amounts for specific periods. As such, the constrained optimization routine 118 may allocate the projected available payment amount for each of the N monthly periods according to the ranked priority list 114 applicable to that monthly period.

In some embodiments, the processor accounts for promotional expiration timestamps occurring within the defined planning horizon 134. As the processor iterates through the N monthly periods, the current processing timestamp advances and may cross promotional expiration timestamps for one or more of the sub-balance entries 110. The processor may recalculate the time-dependent effective APRs 130 at each iteration to capture the transitions from promotional APR to regular APR. In some embodiments, the ranked priority list 114 is regenerated at each iteration to reflect the updated time-dependent effective APRs, potentially reordering sub-balance entries 110 as associated time-dependent effective APRs change.

In some embodiments, the processor terminates the iterative process before completing the N monthly periods when all sub-balance entries reach zero balance amounts. In such embodiments, the processor may detect that the sum of balance amounts across all sub-balance entries equals zero and may therefore determine that no further allocation is required. The number of monthly periods required to reach zero balance across all sub-balance entries may influence a predicted debt-free completion date 138.

In some embodiments, the processor stores the set of subsequent available payment allocations 136 in the non-transitory memory. The set of subsequent available payment allocations 136 may include, for each of the N monthly periods, the allocated amount per sub-balance entry, the projected balance per sub-balance entry after allocation, and the projected interest accrued per sub-balance entry during the period. The stored allocations allows the debt consolidation platform 102 to generate a payment schedule object more efficiently, as described below.

In some embodiments, the processor calculates projected aggregate interest 132 over the defined planning horizon 134 by summing the projected interest accrued across all sub-balance entries and all monthly periods. The projected aggregate interest may represent a total amount of interest the user is expected to pay when the user follows the set of subsequent available payment allocations 136. The processor stores the projected aggregate interest 132 in association with the payment schedule object 120 for presentation to the user via the user device 124.

In some embodiments, the defined planning horizon 134 of N monthly periods is configurable by the user, such that the user specifies the number of monthly periods via the GUI module based on the user's financial goals or desired projection timeframe. In such embodiments, a longer planning horizon may provide more comprehensive projections but requires additional computational resources to process additional iterations. Alternatively, a shorter planning horizon may result in fewer required computational resources by requiring the debt consolidation platform 102 to undertake fewer iterations.

In some embodiments, the processor optimizes computational efficiency by caching intermediate results during the iterative process. For example, the processor may store recalculated time-dependent effective APRs, regenerated ranked priority lists, and/or allocation results for each monthly period in a cache structure. Caching intermediate results enables the processor to resume processing from a specific monthly period without recomputing prior periods when the user modifies parameters affecting only future periods.

In some embodiments, updating the sub-balance data structure 108 after each allocation improves the debt consolidation platform 102 by enabling accurate recalculation of time-dependent effective APRs 130 for subsequent allocation cycles. The processor recalculates time-dependent effective APRs 130 based on the updated balance amounts, such that the ranked priority list 114 reflects current balances rather than stale or static data. Accurate recalculation prevents the constrained optimization routine 118 from allocating payments to sub-balance entries 110 that have already been paid off or from under-allocating the available payment amount 116 to sub-balance entries 110 with increased priority due to balance changes.

In some embodiments, the processor generates a payment schedule object 120 including (i) a set of monthly payment allocations 140 for the N monthly periods and (ii) a predicted debt-free completion date 138 computed from the allocation log and the defined planning horizon 134. In such embodiments, the payment schedule object 120 may be a data structure stored in the non-transitory memory that encapsulates a complete payment plan produced by the constrained optimization routine 118.

In some embodiments, the set of monthly payment allocations 140 includes, for each of the N monthly periods, the allocated amount per sub-balance entry, the allocated amount per credit account, and the total allocated amount for the period. The set of monthly payment allocations 140 may specify how the available payment amount 116 is distributed across sub-balance entries 110 for each future monthly period over the defined planning horizon 134. The processor populates the set of monthly payment allocations 140 from the results of the iterative constrained optimization routine performed over the N monthly periods. As such, the payment schedule object 120 provides the user with an improved visualization of the payment plan calculated and/or determined by the debt consolidation platform 102.

In some embodiments, the set of monthly payment allocations 140 includes projected balance amounts per sub-balance entry after each monthly allocation. The projected balance amounts allow the user to view an expected balance reduction trajectory for each sub-balance entry over the defined planning horizon 134. The processor may calculate the projected balance amounts by subtracting the allocated amount from the balance amount for each sub-balance entry at each monthly period.

In some embodiments, the set of monthly payment allocations 140 includes projected interest accrued per sub-balance entry for each monthly period. In such embodiments, the projected interest accrued may be calculated based on the balance amount and the time-dependent effective APR applicable to the sub-balance entry during the monthly period. As such, the processor may sum the projected interest accrued across all sub-balance entries and all monthly periods to calculate the projected aggregate interest 132 stored as part of the payment schedule object.

In some embodiments, the predicted debt-free completion date 138 is computed from the allocation log and the defined planning horizon 134, such that the processor analyzes the allocation log to identify the monthly period at which the sum of balance amounts across all sub-balance entries reaches zero. In such embodiments, the predicted debt-free completion date may correspond to an end of the monthly period at which all sub-balance entries have zero balance amounts. The processor may compute the predicted debt-free completion date by adding the number of monthly periods required to reach zero balance to the current date.

In some embodiments, the predicted debt-free completion date 138 is computed only when the defined planning horizon 134 of N monthly periods is sufficient to pay off all sub-balance entries 110. When the sum of balance amounts does not reach zero within the N monthly periods, the processor may extrapolate the predicted debt-free completion date 138 based on an average balance reduction rate observed over the defined planning horizon 134. In such embodiments, the processor may indicate that the predicted debt-free completion date 138 is an estimate extending beyond the defined planning horizon 134.

In some embodiments, the payment schedule object 120 includes metadata describing the parameters used to generate the payment schedule object 120. The metadata may include the user-defined monthly budget, the defined constraints applied by the constrained optimization routine 118, the defined planning horizon 134 of N monthly periods, and/or the timestamp at which the payment schedule object 120 is generated. The metadata allows the debt consolidation platform 102 to reproduce the payment schedule object 120 and/or to identify when the payment schedule object 120 requires regeneration due to changes in the parameters.

In some embodiments, the payment schedule object 120 is stored in a serializable data format such as JSON, XML, or a binary format. The serializable data format may allow the debt consolidation platform 102 to transmit the payment schedule object 120 to a remote server for backup, synchronize across multiple user devices, or export the payment schedule object 120 for use in external applications. As such, the processor may serialize the payment schedule object 120 prior to transmission or storage and then may deserialize the payment schedule object 120 upon retrieval.

In some embodiments, the GUI module 122 renders the payment schedule object 120 using a structured visualization including a timeline view and per-account allocation bars and causes display of the timeline view and allocation bars on the user device 124. The timeline view may present the N monthly periods along a horizontal axis with corresponding payment allocations and projected balances. The per-account allocation bars may display an allocated amount for each credit account or sub-balance entry as visual bars proportional to magnitude of allocation. The structured visualization improves the user interface of the debt consolidation platform 102 by providing the user with a simplified visual representation of the payment schedule object 120. Examples of the payment schedule object 120 rendered via the structured visualization are provided below.

In some embodiments, the per-account allocation bars display the allocated payment amount for each credit account or sub-balance entry as visual bars proportional to the allocation magnitude. The per-account allocation bars allow the user to view how the available payment amount 116 is distributed across credit accounts and sub-balance entries 110 for each monthly period. The per-account allocation bars may be displayed horizontally or vertically, with a length or height of each bar corresponding to the allocated amount. The per-account allocation bars may be color-coded to distinguish between different credit accounts, different financial institutions, or different sub-balance types such as regular purchases, balance transfers, and cash advances. The per-account allocation bars may be displayed alongside the timeline view within the structured visualization, allowing the user to view both a projected debt reduction trajectory and payment allocation within in a single interface.

In some embodiments, the debt consolidation platform 102 provides the data records 106, as input, to an AI agent 112 that generates, as output, the payment schedule object 120. The AI agent 112 may receive the data records 106 containing account identifier, sub-balance identifier, balance amount, regular APR, promotional APR, and promotional expiration date for each sub-balance entry. In some embodiments, the AI agent 112 processes the data records 106 and generates the payment schedule object 120 including the set of monthly payment allocations 140 for the N monthly periods and the predicted debt-free completion date 138.

In some embodiments, the AI agent 112 include one or more machine learning models trained to optimize payment allocations across sub-balance entries 110. The one or more machine learning models may receive the data records 106 as input features and may produce payment allocation recommendations as output. The one or more machine learning models may be trained on historical debt repayment data, simulated debt scenarios, or a combination thereof to learn allocation strategies that minimize projected aggregate interest 132 subject to defined constraints. In such embodiments, the one or more machine learning models may include any or all of the following: a neural network, a gradient boosting model, a reinforcement learning agent, and/or other machine learning architecture.

In some embodiments, the AI agent 112 includes a large language model (LLM) configured to process financial data and generate payment schedules. The debt consolidation platform may format the data records 106 as a structured prompt or input sequence provided to the LLM. The LLM may process the input and generates a response containing the payment schedule object 120 or a representation thereof. The debt consolidation platform 102 may parse the response from the LLM to extract the set of monthly payment allocations 140 and the predicted debt-free completion date 138.

In some embodiments, the AI agent 112 is hosted on a remote server accessible via an API. The debt consolidation platform 102 may transmit the data records 106 to the remote server via an API request. The AI agent 112 hosted on the remote server may then process the data records 106 and/or generates the payment schedule object 120. In some embodiments, the remote server transmits the payment schedule object 120 to the debt consolidation platform 102 via an API response. In such embodiments, hosting the AI agent on a remote server may enable access to computational resources exceeding those available on the user device 124 and further enables updates to the AI agent 112 without requiring similar updates to the debt consolidation platform 102 application.

In some embodiments, the AI agent 112 is hosted locally on the computing device executing the debt consolidation platform 102. The AI agent 112 may include a machine learning model or inference engine stored in the non-transitory memory of the computing device. The processor may execute the AI agent 112 locally to process the data records 106 and generate the payment schedule object 120 without transmitting financial data to a remote server. In such embodiments, local execution of the AI agent enhances privacy and reduces computational resource expense associated with transmission by avoiding transmission of sensitive financial data over a network.

In some embodiments, the AI agent 112 generates the payment schedule object 120 by performing the operations of parsing the data records 106, populating the sub-balance data structure 108, computing time-dependent effective APRs 130, generating the ranked priority list 114, allocating the available payment amount 116 using the constrained optimization routine 118, updating the sub-balance data structure 108, recalculating time-dependent effective APRs 130 over the defined planning horizon 134, and/or assembling the payment schedule object 120.

In some embodiments, the AI agent 112 generates multiple candidate payment schedule objects and selects an optimal candidate based on an objective function. In such embodiments, the AI agent 112 may evaluate each candidate payment schedule object according to criteria such as projected aggregate interest 132, predicted debt-free completion date 138, adherence to defined constraints, and/or alignment with user-specified optimization goals. The AI agent may select the payment schedule object 120 that optimizes the objective function and may provide the payment schedule object 120 as output.

In some embodiments, the AI agent 112 adapts its recommended payment allocation strategy based on feedback from the user or from observed outcomes. The debt consolidation platform 102 may provide feedback to the AI agent 112 indicating whether the user followed the recommended payment schedule, whether actual payment amounts matched projected payment amounts, or whether the user expressed satisfaction with the recommendations. The AI agent 112 may incorporate the feedback to refine its allocation strategy for subsequent payment schedule generation. In such embodiments, the AI agent may implement online learning or reinforcement learning techniques to continuously improve allocation recommendations.

In some embodiments, the user submits a natural language prompt to the AI agent 112. The natural language prompt may include a query or instruction expressed in human language regarding credit card debt optimization. In some embodiments, the AI agent 112 receives the natural language prompt and interprets the prompt to determine a requested debt optimization operation. The prompt may include a query regarding credit card debt optimization, which may cause the AI agent 112 to invoke a debt optimization tool configured to perform partition-aware debt modeling, and the AI agent may present results from the tool to the user.

In some embodiments, the natural language prompt includes a general request for debt optimization assistance. For example, the user may ask the AI agent 112 a query such as “Help me pay off my credit cards.” The AI agent 112 may then call a debt optimization tool, and the tool may perform partition-aware calculation, and the AI agent 112 may present results to the user (e.g., the payment schedule object 120) The AI agent may interpret the general request, retrieve or request the data records 106 from the user, provide the data records 106 to the debt optimization module, and/or generate the payment schedule object 120 in response to the natural language prompt.

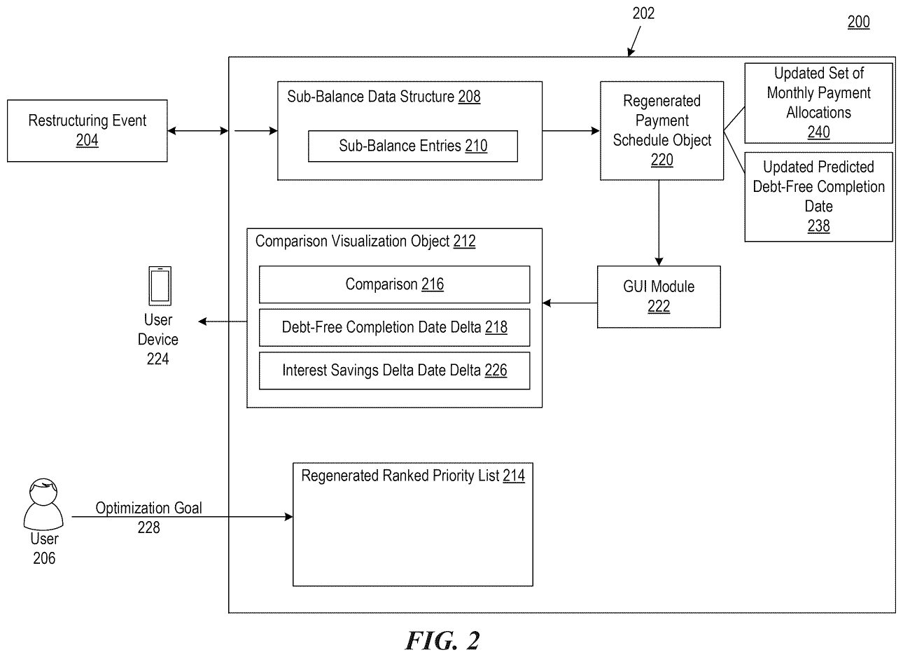

FIG. 2 illustrates a second example of a debt consolidation environment 200 providing a debt consolidation platform 202. The debt consolidation platform 202 may be the same as or similar to the debt consolidation platform 102 as described in relation to FIG. 1, above. The debt consolidation environment 200 can be implemented using components of the example computer system illustrated and described in more detail with reference to FIG. 14 below. Likewise, implementations of the example debt consolidation environment 200 can include different and/or additional components or can be connected in different ways.

In some embodiments, the processor automatically detects an occurrence of a restructuring event 204. The restructuring event 204 may represent a change in the user's financial circumstances or preferences that can impact the payment schedule object 120. As such, the processor may monitor for restructuring events during a session of the debt consolidation platform and may initiate automatic processing upon detection without requiring a user 206 to manually trigger any recalculation when the restructuring event 204 occurs.

In some embodiments, the restructuring event 204 includes an acceptance, by the user 206, of a balance transfer offer to transfer a balance from a first sub-balance entry to a second sub-balance entry. The user may accept the balance transfer offer from a financial institution to move a balance from an existing sub-balance entry to a new sub-balance entry, typically with a promotional APR and promotional expiration date. In such embodiments the processor may detect the acceptance when the user inputs the balance transfer details via a GUI module 222, when the debt consolidation platform 202 receives notification from a financial institution API, or when the processor identifies a new sub-balance entry in updated data records. Upon detection, the processor may automatically recognize that the balance amount of the first sub-balance entry is reduced, and a new second sub-balance entry is created with the transferred balance amount, a balance transfer fee if applicable, the promotional APR, and/or the promotional expiration timestamp. The GUI module 222 may be the same as or similar to the GUI module 122 as described in relation to FIG. 1, above.

In some embodiments, the restructuring event 204 includes an expiration of the promotional APR associated with a sub-balance entry. The processor may monitor the promotional expiration timestamps stored in the sub-balance data structure 208 and may compare each promotional expiration timestamp to the current processing timestamp. In some embodiments, when the current processing timestamp equals or exceeds a promotional expiration timestamp, the processor detects that the promotional APR has expired for the associated sub-balance entry. As such, the time-dependent effective APR for the sub-balance entry may transition from the promotional APR to the regular APR upon expiration. In some embodiments, the processor detects this transition automatically without requiring user input. The sub-balance data structure 208 may be the same as or similar to the sub-balance data structure 108 as described in relation to FIG. 1, above.

In some embodiments, the restructuring event 204 includes a variance between an actual payment amount and a projected payment amount. In such embodiments, the processor may compare actual payment amounts recorded in the allocation log or received from financial institution data records to projected payment amounts stored in the payment schedule object (e.g., the payment schedule object 120). When the difference between the actual payment amount and the projected payment amount exceeds a predefined threshold, the processor may detect a variance restructuring event. The variance indicates that the user 206 paid more or less than the projected amount, which in turn may affect the balance amounts and the projected debt-free completion date (e.g., the predicted debt-free completion date 138).

In some embodiments, the restructuring event 204 includes a change, initiated by the user 206, in a payment allocation strategy. For example, the user may select a different payment allocation strategy via the GUI module 222, such as switching from highest effective APR prioritization to lowest balance prioritization, or selecting a hybrid strategy, or specifying custom prioritization rules. As such, the processor may detect the change when the user 206 submits the new strategy selection. The change in payment allocation strategy may affect how the constrained optimization routine (e.g., the constrained optimization routine 118) allocates the available payment amount (e.g., the available payment amount 116) across sub-balance entries 210. The sub-balance entries 210 may be the same as or similar to the sub-balance entries 110 as described in relation to FIG. 1 above.

In some embodiments, the restructuring event includes an adjustment, initiated by the user, to the available payment amount. The user may modify the user-defined monthly budget via the GUI module 222, increasing or decreasing the amount available for debt repayment each month. The processor may detect the adjustment when the user 206 submits the new available payment amount. In some embodiments, the adjustment affects the constrained optimization routine by changing the total funds available for allocation across sub-balance entries.

In some embodiments, automatic detection of restructuring events improves the debt consolidation platform 202 by eliminating a need for the user 206 to manually monitor financial conditions and/or initiate recalculation. For example, the processor may continuously monitor for the five types, or more types, of restructuring events across all sub-balance entries simultaneously, detecting changes that are difficult or impossible for the user 206 to track manually across multiple credit accounts from multiple financial institutions. As such, the automatic detection enables the debt consolidation platform 202 to respond to restructuring events within milliseconds of occurrence, providing real-time responsiveness that exceeds human reaction time. The processor performs complex comparisons between current processing timestamps and promotional expiration timestamps, between actual payment amounts and projected payment amounts, and between current and prior parameter values, executing the comparisons automatically without consuming user attention or requiring user expertise in financial calculations.

In some embodiments, in response to automatically detecting the occurrence of the restructuring event 204, during a session of the debt consolidation platform 202, the processor automatically updates the sub-balance data structure to reflect the occurrence of the restructuring event 204. The sub-balance data structure 208 may be the same as or similar to the sub-balance data structure 108 as described in relation to FIG. 1, above.

In some embodiments, when the restructuring event 204 is an acceptance of a balance transfer offer, the processor updates the sub-balance data structure 208 by reducing the balance amount of the first sub-balance entry by the transferred amount, creating a new second sub-balance entry with the transferred balance amount plus any balance transfer fee, and/or populating the promotional APR, regular APR, and promotional expiration timestamp fields of the new sub-balance entry with values obtained from the balance transfer offer.

In some embodiments, when the restructuring event 204 is an expiration of the promotional APR, the processor updates the sub-balance data structure 208 by recalculating the time-dependent effective APR for the affected sub-balance entry. The function (e.g., the function 128) may assign the regular APR as the time-dependent effective APR when the current processing timestamp is on or after the promotional expiration timestamp.

In some embodiments, when the restructuring event 204 is a variance between an actual payment amount and a projected payment amount, the processor updates the sub-balance data structure 208 by adjusting the balance amounts of sub-balance entries 210 to reflect the actual payments made. As such, the processor may reduce balance amounts according to the actual payment allocation rather than the projected payment allocation. In some embodiments, when the restructuring event 204 is a change in payment allocation strategy, the processor updates parameters associated with the constrained optimization routine to reflect the new strategy. The processor may store the changed payment allocation strategy in association with the sub-balance data structure 208.

In some embodiments, when the restructuring event 204 is an adjustment to the available payment amount, the processor updates the user-defined monthly budget parameter used by the constrained optimization routine. The updated available payment amount is applied to subsequent allocation calculations. The available payment amount may be the same as or similar to the available payment amount 116 as described in relation to FIG. 1, above.

In some embodiments, automatic updating the sub-balance data structure 208 improves computational resource efficiency by performing targeted updates to affected sub-balance entries rather than re-ingesting and re-parsing all data records. The processor may identify specific sub-balance entries affected by the restructuring event 204 and may modify only those entries, preserving unchanged entries without redundant processing. Automatic updating reduces latency between detection of the restructuring event 204 and availability of updated data for regeneration of the payment schedule object (e.g., as regenerated payment schedule object 220). In some embodiments, the processor propagates effects of the restructuring event 204 through the sub-balance data structure 208, updating interdependent values such as time-dependent effective APRs and balance amounts in a single processing pass. Automatic updating improves data consistency by applying updates automatically, preventing the debt consolidation platform 202 from operating on partially updated data that could produce incorrect payment schedule calculations for the user 206.

In some embodiments, the processor regenerates the payment schedule object to produce the regenerated payment schedule object 220. The regenerated payment schedule object 220 may be substantially the same as the payment schedule object 120 in structure and method of calculation but includes an updated set of monthly payment allocations 240 for the N monthly periods and an updated predicted debt-free completion date 238.

In some embodiments, the processor regenerates the payment schedule object by re-executing the constrained optimization routine using the updated sub-balance data structure. The processor may recalculate time-dependent effective APRs for all sub-balance entries 210, regenerate the ranked priority list, allocate the available payment amount according to the regenerated ranked priority list, and may iterate over the N monthly periods to produce the updated set of monthly payment allocations. In some embodiments, the processor computes the updated predicted debt-free completion date 238 based on the monthly period at which all sub-balance entries 210 reach zero balance amounts.

In some embodiments, the processor retains the payment schedule object prior to regeneration. The payment schedule object may operate as a baseline for comparison with the regenerated payment schedule object 220. The processor may store both the payment schedule object and the regenerated payment schedule object 220 in the non-transitory memory to enable generation of a comparison visualization object 212 via the GUI module 222.

In some embodiments, regeneration of the payment schedule object improves the debt consolidation platform 202 by performing complex, multi-period optimization calculations automatically in response to detecting the occurrence of the restructuring event 204. In such embodiments, the processor may iterate through the N monthly periods, recalculating time-dependent effective APRs at each period as promotional expirations occur, regenerating ranked priority lists as effective APRs change, and/or reallocating payment amounts according to updated priorities. The regeneration accounts for interdependencies among sub-balance entries 210 across the defined planning horizon (e.g., the defined planning horizon 134), propagating any effects of the restructuring event 204 through all subsequent monthly periods. The processor may perform hundreds or thousands of individual calculations to produce the regenerated payment schedule object 220, executing these calculations within milliseconds and without requiring user expertise in financial optimization. Regeneration allows the user 206 to immediately view impacts of the restructuring event 204 on the payment plan without manually recalculating payment allocations, interest accrual, and/or payoff timelines.

In some embodiments, the GUI module 222 renders, during the session, the comparison visualization object 212 and causes display of the comparison visualization object 212 on a user device 224. The user device 224 may be the same as or similar to the user device 124 as described in relation to FIG. 1, above.

In some embodiments, the comparison visualization object 212 presents a comparison 216 of the payment schedule object and the regenerated payment schedule object 220. The comparison 216 may display the set of monthly payment allocations alongside the updated set of monthly payment allocations 240, enabling the user to view how the restructuring event 204 impacts the payment plan.

In some embodiments, the comparison visualization object 212 presents a debt-free completion date delta 218 representing a difference between the predicted debt-free completion date and the updated predicted debt-free completion date 238. The debt-free completion date delta 218 may indicate whether the restructuring event accelerates or delays a projected payoff date (e.g., debt-free completion date). A negative delta may indicate the user 206 will likely become debt-free sooner than originally projected as a result of the restructuring event 204. Additionally, a positive delta may indicate that the user 206 will become debt-free later than originally projected. In some embodiments, the GUI module 222 displays the debt-free completion date delta 218 as a number of days, weeks, months, or years, depending on a magnitude of the delta.

In some embodiments, the comparison visualization object 212 presents an interest savings delta 226 representing a difference between a first projected aggregate interest associated with the payment schedule object and a second projected aggregate interest associated with the regenerated payment schedule object 220. The interest savings delta may indicate whether the restructuring event 204 reduces or increases the total interest (e.g., projected aggregate interest 132) the user 206 is projected to pay. A positive interest savings delta may indicate the user 206 will pay less interest than originally projected. A negative interest savings delta may indicate the user 206 will pay more interest than originally projected. The GUI module 222 displays the interest savings delta 226 as a currency amount (e.g., USD) and/or optionally as a percentage reduction or increase.

In some embodiments, the comparison visualization object 212 is rendered within the same session of the debt consolidation platform 202 in which the restructuring event 204 is detected. In such embodiments, the user 206 may view the comparison visualization object 212 without requiring termination and/or restarting of the session. The automatic detection, automatic updating, regeneration, and rendering occur in response to the restructuring event 204 without requiring the user 206 to navigate to a separate interface or initiate a manual comparison process.

In some embodiments, the comparison visualization object 212 includes interactive elements enabling the user to explore the differences between the payment schedule object and the regenerated payment schedule object 220. As such, the user 206 may select individual monthly periods to view detailed allocation differences, hover over sub-balance entries 210 to view balance trajectory differences, and/or toggle between baseline and regenerated views. The interactive elements may enable the user to understand an impact of the restructuring event at varying levels of detail.

In some embodiments, the comparison visualization object 212 improves the display of the interface of the debt consolidation platform 202 by presenting quantitative impact metrics that enable the user 206 to make informed financial decisions. The debt-free completion date delta 218 and/or the interest savings delta 226 provide concrete, actionable information that the user 206 may use to evaluate whether the restructuring event 204 is beneficial towards user goals. The comparison visualization object 212 may eliminate a need for the user 206 to manually compare two payment schedules, calculate differences in payoff dates, and/or compute interest savings, performing calculations that would be difficult and/or impossible for the user 206 and reducing potential for calculation errors. The side-by-side presentation of the payment schedule object and the regenerated payment schedule object 220 in the comparison visualization object 212 allows the user 206 to easily visually identify changes in allocation patterns, balance trajectories, and/or payoff timelines. In some embodiments, the GUI module 222 renders the comparison visualization object 212 using pre-computed values from the payment schedule object and the regenerated payment schedule object 220, reducing computational resource expense by avoiding redundant calculations during rendering. The comparison visualization object 212 may provide immediate feedback to the user 206 following the restructuring event 204, allowing the user to assess the impact of financial decisions in real time and adjust strategies accordingly.

In some embodiments, performing the automatic detection, automatic updating, regeneration, and rendering within the same session of the debt consolidation platform 202 improves the platform by providing continuous, uninterrupted debt optimization without requiring the user 206 to terminate and/or restart the application. The user 206 maintains relevant context throughout the session, views a progression of changes to the payment schedule object as restructuring events occur without losing the payment schedule object or prior comparison visualization objects. Performing the operations within the same session eliminates a latency and computational overhead associated with session initialization, data re-ingestion, re-parsing of data records, and/or re-population of the sub-balance data structure 208 that would otherwise be required if the user 206 were forced to restart the session to view the regenerated payment schedule object 220.

In some embodiments, same-session processing enables the debt consolidation platform 202 to retain the payment schedule object in memory for comparison with the regenerated payment schedule object 220. If the user 206 were required to terminate the session and start a new session, the payment schedule object would be discarded, and the debt consolidation platform 202 would be unable to generate the comparison visualization object 212 presenting the debt-free completion date delta 218 and the interest savings delta 226. As such, the comparison visualization object 212 provides information to the user 206 that depends on an availability of both the payment schedule object and the regenerated payment schedule object 220 within the same session.

In some embodiments, same-session processing enables the user to evaluate multiple restructuring events in sequence and observe cumulative effects on the payment schedule object. For example, the debt consolidation platform 202 may detect a second occurrence of a second restructuring event. The second restructuring event may be one of the restructuring events discussed above, and the debt consolidation platform 202 may detect the second restructuring event in substantially the same way as the restructuring event 204. For example, the user may accept a balance transfer offer (e.g., the restructuring event 204), view the comparison visualization object 212, then adjusts the available payment amount (e.g., the second restructuring event), views a second comparison visualization object, and may continue iterating through potential restructuring events without restarting the session. Each subsequent regeneration uses a most recent payment schedule object as a new baseline, which allows for cascading recalculation that reflects a cumulative impact of multiple restructuring events. The ability for iterative scenario testing (e.g., multiple restructuring events) would be unavailable and impossible were the user required to restart the session after each restructuring event.

The second restructuring event may be associated with a second regenerated payment schedule object, a second updated set of monthly payment allocations for the N monthly periods, and/or a second updated predicted debt-free completion date. The GUI module 222 may render, during the session, a second comparison visualization object presenting a second comparison of the second regenerated payment schedule object and the regenerated payment schedule object 220, a second debt-free completion date delta representing a difference between the updated predicted debt-free completion date 238 and the second updated predicted debt-free completion date, and a second interest savings delta representing a second difference between the second projected aggregate interest and a third projected aggregate interest associated with the second regenerated payment schedule object. Subsequent restructuring event detections may cause the debt consolidation platform 202 to compare the associated elements of a most recently created payment schedule object with associated components with the associated elements of a newly created payment schedule object with associated components, as described above.

In some embodiments, same-session processing reduces computational resource expense by reusing data structures, cached calculations, and memory allocations across multiple restructuring events. The sub-balance data structure 208, the ranked priority list, and intermediate calculation results may remain in the non-transitory memory throughout the session, allowing the processor to perform incremental updates rather than full re-computation of all relevant financial data. The debt consolidation platform 202 likewise may avoid repeated authentication with financial institution APIs, repeated ingestion of data records, and/or repeated parsing operations are required when the session is terminated and restarted.

In some embodiments, the debt consolidation platform 202 receives an optimization goal 228 from the user 206. The user-specified optimization goal may indicate a preferred objective for debt repayment. As such, the debt consolidation platform 202 may present available optimization goals to the user 206 via the GUI module 222, and the user 206 may select one of the available optimization goals. Alternatively, the user 206 may provide the optimization goal 228 as a natural language prompt to an AI agent of the debt consolidation platform, such as the AI agent 112 as described in relation to FIG. 1, above.

In some embodiments, the optimization goal 228 includes minimizing the projected aggregate interest, such as the projected aggregate interest 132 as described in relation to FIG. 1 above. The user 206 may prioritize paying the least total amount of interest possible over the defined planning horizon, even when such an optimization goal 228 results in a long payoff period or high monthly payments. In such embodiments, the processor may configure the constrained optimization routine to allocate available payment amounts to sub-balance entries 210 in a manner that reduces total interest accrued across all sub-balance entries and/or all monthly periods. As such, minimizing projected aggregate interest may result in prioritizing the sub-balance entries 210 with the highest time-dependent effective APRs, which accrue interest at a fastest rate.

In some embodiments, the optimization goal 228 includes achieving a debt-free status by a target date. In such embodiments, the user 206 may specify a target date by which the user 206 desires to have zero balance across all sub-balance entries 210. The processor may configure the constrained optimization routine to calculate a required monthly payment amount to achieve zero balance by the target date and/or to allocate payments accordingly. When the monthly budget, as calculated or specified by the user 206 is insufficient to achieve the target date, the processor calculates and displays a minimum monthly payment required to meet the target date, allowing the user to adjust the available payment amount or select a different target date.

In some embodiments, the optimization goal 228 includes minimizing the set of monthly payment allocations for the N monthly periods. As such, the user 206 may prioritize paying a lowest monthly amount while making progress towards debt repayment. The processor may configure the constrained optimization routine to allocate the minimum payment amounts required by each credit account and/or to minimize excess payments beyond the minimum requirements. Minimizing monthly payment allocations may result in a longer payoff period and higher projected aggregate interest but may provide the user 206 with greater monthly cash flow for other financial needs outside of the debt consolidation platform 202.

In some embodiments, the optimization goal 228 includes maximizing a credit score improvement. In such embodiments, the user 206 may prioritize improving credit score metrics, such as credit utilization ratio, over minimizing interest or accelerating debt payoff. The processor may configure the constrained optimization routine to allocate payments in a manner that reduces credit utilization across credit accounts, prioritizes accounts with high utilization ratios or accounts approaching credit limits. Maximizing credit score improvement may result in allocating payments to sub-balance entries 210 with lower time-dependent effective APRs when those sub-balance entries are associated with accounts having high credit utilization, for example.

In some embodiments, the processor automatically regenerates the ranked priority list based on the optimization goal 228, to produce a regenerated ranked priority list 215. The regenerated ranked priority list 214 may determine an order in which sub-balance entries 210 receive payment allocation. For example, when the optimization goal 228 is minimizing projected aggregate interest, the processor may produce the regenerated ranked priority list 214 by sorting sub-balance entries 210 in descending order by time-dependent effective APR, prioritizing sub-balance entries 210 that accrue interest at the fastest rate. Other optimization goals may result in different regenerated ranked priority lists based on the optimization goal 228 and the constraints imposed on the constrained optimization routine by the optimization goal 228.

In some embodiments, the processor regenerates the ranked priority list automatically in response to receiving the optimization goal 228, without requiring additional action by the user 206. The user 206 may select the optimization goal 228 via the GUI module 222, and the processor, in response, may immediately regenerate the ranked priority list, re-execute the constrained optimization routine, and/or regenerate the payment schedule object to reflect the optimization goal 228. The automatic regeneration allows the user 206 to compare payment schedule objects under different optimization goals by selecting each goal in sequence and viewing a resulting payment schedule.

In some embodiments, receiving the optimization goal 228 and automatically regenerating the ranked priority list improves the debt consolidation platform 202 by allowing personalized debt repayment strategies tailored to the preferences/goals of the user 206. Different users have different financial priorities, and as such, a single optimization strategy does not serve all users equally. For example, a first user with limited monthly cash flow may benefit from minimizing monthly payment allocations, while a second user with available funds may benefit from minimizing projected aggregate interest. As such, the debt consolidation platform accommodates diverse needs of various users by enabling the user 206 to select the optimization goal 228 that aligns with the user's priorities and/or financial needs.

In some embodiments, automatically regenerating the ranked priority list based on the optimization goal 228 improves computational efficiency of the debt consolidation platform 202 by reusing the sub-balance data structure 208 and recalculating only the components (e.g., sub-balance entries 210) affected by the optimization goal 228. The processor may not re-ingest data records, re-parse data records, and/or re-populate the entire sub-balance data structure when the user provides the optimization goal 228. The processor may retrieve the existing sub-balance entries from the sub-balance data structure 208, apply a sorting criterion based on the optimization goal 228, and produces the regenerated ranked priority list 214. The constrained optimization routine may operate on the regenerated ranked priority list 214 using the same allocation logic as described above, producing the regenerated payment schedule object 220 with minimal computational overhead. The efficient regeneration allows the user to compare payment schedules under different optimization goals without incurring a latency associated with full generation of the sub-balance data structure 208.

In some embodiments, automatically regenerating the ranked priority list improves the display of the interface associated with the debt consolidation platform 202 by providing immediate visual feedback when the user 206 selects the optimization goal 228. The GUI module 222 may render the regenerated payment schedule object 220 within milliseconds of the user's selection, allowing the user 206 to observe how the optimization goal 228 affects monthly payment allocations, the predicted debt-free completion date, and/or the projected aggregate interest.

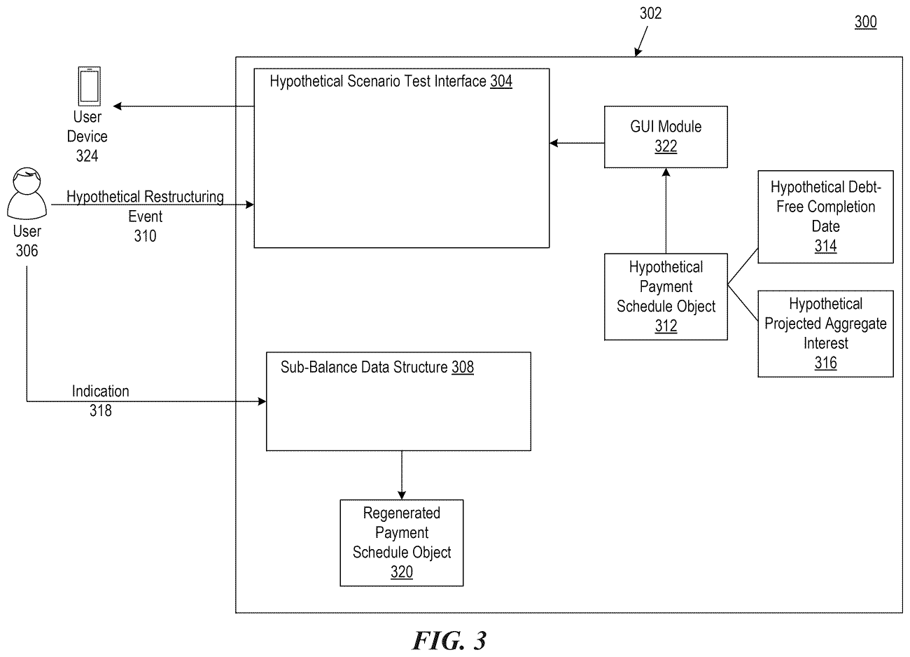

FIG. 3 illustrates a third example of a debt consolidation environment 300 providing a debt consolidation platform 302. The debt consolidation platform 302 can be the same as or similar to the debt consolidation platform 102 as described in relation to FIG. 1 above, and the debt consolidation platform 202 as described in relation to FIG. 2 above. The debt consolidation environment 300 can be implemented using components of the example computer system illustrated and described in more detail with reference to FIG. 14 below. Likewise, implementations of the example debt consolidation environment 300 can include different and/or additional components or can be connected in different ways.

In some embodiments, a GUI module 322 renders a hypothetical scenario test interface 304 and causes display of the hypothetical scenario test interface 304 on a user device 324. The GUI module 322 can be the same as the GUI module 222 as described in relation to FIG. 2, or the GUI module 122 as described in relation to FIG. 1 above. The user device 324 can be the same as the user device 224 or the user device 124 as described in relation to FIG. 2 or FIG. 1 above, respectively. The hypothetical scenario test interface 304 may provide a dedicated interface within the debt consolidation platform 302 where the user may explore potential financial decisions without committing to those decisions (e.g., recalculating the payment schedule object). The user may be the same as or similar to the user 206 as described in relation to FIG. 2 above. The hypothetical scenario test interface 304 may be visually distinguished from other interfaces of the debt consolidation platform 302 to indicate to the user that interactions within the hypothetical scenario test interface 304 do not affect the payment schedule object. The payment schedule object may be the same as or similar to the payment schedule object 120 as described in relation to FIG. 1 above.

In some embodiments, the user specifies, via the hypothetical scenario test interface 304, a hypothetical restructuring event 310 to be applied to the payment schedule object without modifying the payment schedule object. The hypothetical restructuring event 310 may represent a potential future financial change that the user is considering but has not yet committed to. Additionally or alternatively, the hypothetical restructuring event 310 may represent a potential financial event, and the user hopes to see a potential impact of said potential financial event on the user's debt profile (e.g., through regenerating the payment schedule object). The user may specify the hypothetical restructuring event 310 by entering parameters via input fields, dropdown menus, sliders, or other interactive elements within the hypothetical scenario test interface 304. The hypothetical restructuring event 310 includes one of (i) a hypothetical acceptance of a balance transfer offer to transfer a balance from a first sub-balance entry to a second sub-balance entry, (ii) a hypothetical expiration of a promotional APR associated with a sub-balance entry, (iii) a hypothetical variance between an actual payment amount and a projected payment amount, (iv) a hypothetical change in a payment allocation strategy, or (v) a hypothetical adjustment to the available payment amount. The available payment amount may be the same as or similar to the available payment amount 116 as described in relation to FIG. 1 above.

In some embodiments, when the hypothetical restructuring event is a hypothetical acceptance of a balance transfer offer, the user specifies parameters including the first sub-balance entry from which the balance will be transferred, the transfer amount, a balance transfer fee, the promotional APR of the second sub-balance entry, and/or the promotional expiration date of the second sub-balance entry. The hypothetical scenario test interface 304 may present input fields for each parameter and may validate user input to ensure the specified parameters are within acceptable or possible ranges.

In some embodiments, when the hypothetical restructuring event 310 is a hypothetical adjustment to the available payment amount, the user specifies a hypothetical monthly budget that differs from the current user-defined monthly budget. The user may enter the hypothetical monthly budget via a numeric input field or adjusts the hypothetical monthly budget via a slider control. In some embodiments, the hypothetical scenario test interface 304 displays the current user-defined monthly budget alongside the hypothetical monthly budget to enable the user to compare the values.

In some embodiments, the processor generates a hypothetical payment schedule object 312 by applying the hypothetical restructuring event 310 to the payment schedule object without modifying the payment schedule object. The processor may create a copy of the sub-balance data structure 308 in the non-transitory memory, may apply the hypothetical restructuring event 310 to the copied sub-balance data structure, and/or may execute the constrained optimization routine using the copied sub-balance data structure to produce the hypothetical payment schedule object 312. The constrained optimization routine may be the same as or similar to the constrained optimization routine 118 as described in relation to FIG. 1 above. The original sub-balance data structure and the payment schedule object may both remain unchanged in the non-transitory memory. In some embodiments, the hypothetical payment schedule object 312 includes a hypothetical set of monthly payment allocations for the N monthly periods and a hypothetical debt-free completion date 314.

In some embodiments, the processor calculates a set of hypothetical impact metrics including (i) a hypothetical debt-free completion date 314 and (ii) a hypothetical projected aggregate interest 316. The hypothetical debt-free completion date 314 may represent a date at which all sub-balance entries would reach zero balance when the hypothetical restructuring event 310 is applied. The hypothetical projected aggregate interest 316 may represent a total amount of interest the user will pay over the planning horizon when the hypothetical restructuring event 310 is applied. In some embodiments, the processor calculates the hypothetical impact metrics from the hypothetical payment schedule object 312 using the same or similar calculation methods applied to the payment schedule object.

In some embodiments, the GUI module 322 renders the hypothetical payment schedule object 312 alongside the payment schedule object in a non-destructive comparison mode and causes display of the non-destructive comparison mode on the user device 324 within the hypothetical scenario test interface 304. The non-destructive comparison mode may present the payment schedule object and the hypothetical payment schedule object 312 in a side-by-side arrangement, such that the user may visually compare the two payment schedules. The non-destructive comparison mode may further display the predicted debt-free completion date associated with the payment schedule object alongside the hypothetical debt-free completion date 314 associated with the hypothetical payment schedule object 312. Likewise, the non-destructive comparison mode may display the projected aggregate interest associated with the payment schedule object alongside the hypothetical projected aggregate interest 316 associated with the hypothetical payment schedule object 312.

In some embodiments, the non-destructive comparison mode provides one or more interactive GUI elements through which the user can alter one or more parameters of the hypothetical restructuring event 310. The interactive GUI elements may include input fields, sliders, dropdown menus, toggle switches, or other controls that allow the user to modify the parameters of the hypothetical restructuring event 310. When the user alters a parameter via an interactive GUI element, the processor may regenerate the hypothetical payment schedule object 312 and may recalculate the hypothetical impact metrics based on the altered parameter. As such, the GUI module 322 may update the non-destructive comparison mode to reflect the hypothetical payment schedule object 312 and recalculated hypothetical impact metrics. The interactive GUI elements enable the user to test variations of the hypothetical restructuring event 310 without navigating away from the hypothetical scenario test interface 304 or restarting the hypothetical scenario.

In some embodiments, the debt consolidation platform 302 receives an indication 318, from the user, to apply the hypothetical restructuring event 310 to the payment schedule object. The indication may include a user interaction with a commit button, confirmation dialog, or other GUI element within the hypothetical scenario test interface 304 that signals to the debt consolidation platform 302 that the user intends to convert the hypothetical restructuring event 310 into an actual restructuring event (e.g., restructuring event 204. In some embodiments, the GUI module 322 presents the commit button or confirmation dialog after the user reviews the hypothetical payment schedule object 312 and/or the hypothetical impact metrics in the non-destructive comparison mode.

In some embodiments, in response to receiving the indication 318, the processor updates the sub-balance data structure 308 to reflect the hypothetical restructuring event 310 and regenerates the payment schedule object. In such embodiments, the processor may apply the hypothetical restructuring event 310 to the sub-balance data structure 308, modifying the balance amounts, promotional APRs, promotional expiration timestamps, or other fields associated with any or all of the sub-balance entries as specified by the hypothetical restructuring event 310. The processor may execute the constrained optimization routine using the sub-balance data structure 308 to regenerate the payment schedule object. The regenerated payment schedule object 320 may replace the payment schedule object as an active payment schedule object. In some embodiments, the hypothetical payment schedule object 312 is discarded or archived after the hypothetical restructuring event 310 is committed via the indication 318.

In some embodiments, the hypothetical scenario test interface 304 improves the debt consolidation platform 302 by allowing the user to evaluate potential financial decisions before committing to those decisions by providing the indication 318. The user may explore an impact of accepting a balance transfer offer, adjusting a monthly budget, or changing a payment allocation strategy without affecting the sub-balance data structure 308 and/or the payment schedule object. In some embodiments, the user is able to provide the indication 318 only after reviewing the hypothetical debt-free completion date 314, the hypothetical projected aggregate interest 316, and/or the comparison with the payment schedule object.

In some embodiments, generating the hypothetical payment schedule object without modifying the original payment schedule object improves computational resource efficiency by avoiding unnecessary regeneration of the payment schedule object. The processor may generate the hypothetical payment schedule object 312 using a copy of the sub-balance data structure 308, preserving the sub-balance data structure 308 and/or the payment schedule object in a current state. When the user decides not to commit the hypothetical restructuring event 310, the processor may discard the hypothetical payment schedule object 312 and/or the copy of the sub-balance data structure 308 without expending computational resources to restore the original/previous state. As such, the debt consolidation platform 302 may avoid a computational expense of regenerating the payment schedule object twice—once to apply the hypothetical restructuring event 310 and once to revert the hypothetical restructuring event 310 when the user decides not to commit.

In some embodiments, the non-destructive comparison mode improves the display of the user interface of the debt consolidation platform 302 by presenting the payment schedule object and the hypothetical payment schedule object 312 simultaneously. The user may view both payment schedule objects without switching between screens, toggling views, or relying on memory to compare values.

In some embodiments, the interactive GUI elements within the non-destructive comparison mode improve the user interface by allowing the user to iterate on parameters of the hypothetical restructuring event 310. For example, the user may adjust a slider to modify a hypothetical balance transfer amount and may immediately observe an impact on the hypothetical debt-free completion date 314 and/or the hypothetical projected aggregate interest 316. The immediate feedback provided by the interactive GUI elements provides the user with an improved ability for data-driven financial decision-making.

In some embodiments, the hypothetical scenario test interface 304 allows the user to evaluate multiple hypothetical restructuring events in sequence without committing to any of them. The user may specify a first hypothetical restructuring event, reviews associated hypothetical impact metrics, then modify the parameters or specify a different hypothetical restructuring event, review updated hypothetical impact metrics and continue iterating until identifying a preferred hypothetical restructuring event. The processor may generate a new hypothetical payment schedule object for each hypothetical restructuring event without accumulating changes to the payment schedule object. The user may commit to one preferred hypothetical restructuring event, and the processor applies only that hypothetical restructuring event to the sub-balance data structure 308 and regenerates the payment schedule object once. The workflow described above reduces computational resource expense by avoiding multiple consecutive regenerations of the payment schedule object while the user is engaged with the hypothetical scenario test interface.

### Example Debt Consolidation Platform Interfaces

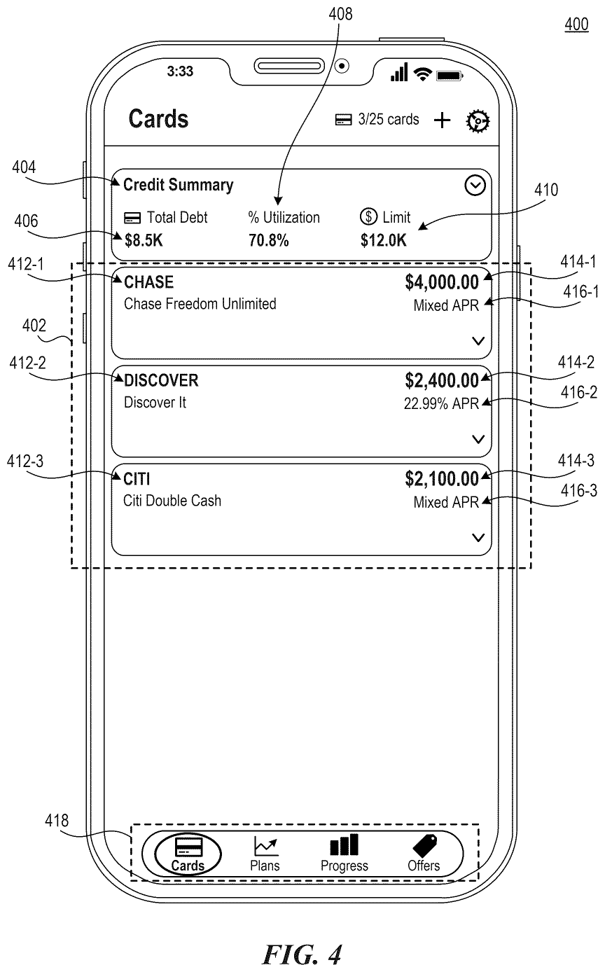

FIG. 4 illustrates an example of a user interface 400 of a debt consolidation platform displaying a sub-balance data structure. The sub-balance data structure 402 displayed in FIG. 4 may be the same as or similar to the sub-balance data structure 108, the sub-balance data structure 208, or the sub-balance data structure 308 as described in relation to FIG. 1, FIG. 2, or FIG. 3, above, respectively.

In some embodiments, the display includes a credit summary 404. The credit summary 404 may present aggregate metrics across some or all credit accounts and some or all sub-balance entries in the sub-balance data structure 402. The credit summary 404 may display a total debt 406 representing a sum of balance amounts across all sub-balance entries in the sub-balance data structure 402. In some embodiments, the credit summary 404 also displays a total credit utilization 408 representing a ratio of total debt 406 to total credit limit 410 across all credit accounts, expressed as a percentage. The credit summary may likewise display the total credit limit 410 representing a sum of credit limits across all credit accounts. In some embodiments, the credit summary 404 provides the user with a view of summary financial metrics without navigating to individual credit accounts or sub-balance entries. The user interface 400 may display none, some, or all of the aggregate metrics within the credit summary 404, including but not limited to the total debt 406, the total credit utilization 408, and/or the total credit limit 410.

In some embodiments, the sub-balance data structure 402 provides display of one or more financial institutions 412. For example, the sub-balance data structure 402 may display a first financial institution 412-1, a second financial institution 412-2, and a third financial institution 412-3. In the example of FIG. 4, the first financial institution 412-1 is Chase, the second financial institution 412-2 is Discover, and the third financial institution 412-3 is Citi. The one or more financial institutions 412 displayed in FIG. 4 are non-limiting examples, and the display may include any number of financial institutions with which the user has credit accounts. The user interface 400 may organize sub-balance entries by financial institution, allowing the user to view debt associated with each financial institution in a summary display.

In some embodiments, each financial institution displayed in the sub-balance data structure 402 presents a debt amount associated with the one or more credit accounts the user has with each financial institution. The debt amount may represent a sum of balance amounts across all sub-balance entries associated with credit accounts issued by the financial institution. For example, the user has a first debt amount 414-1 of $4,000 associated with Chase, a second debt amount 414-2 of $2,400 associated with Discover, and a third debt amount 414-3 of $2,100 associated with Citi. The user interface 400 allows the user to compare debt amounts 414 across the one or more financial institutions 412, and to identify which financial institutions hold the largest portions of the total debt 406.

In some embodiments, the display indicates an APR associated with each financial institution. For example, when the user has multiple sub-balance entries with different APRs associated with a financial institution, the sub-balance data structure 402 may indicate a mixed APR designation. The mixed APR designation may inform the user that the sub-balance entries associated with the financial institution have varying time-dependent effective APRs 416 and that a single APR value does not accurately represent the interest rate applicable to all sub-balance entries. When the sub-balance entries associated with a financial institution all have the same time-dependent effective APR, the sub-balance data structure 402 may provide the actual time-dependent effective APR. Additionally or alternatively, when the user has a single sub-balance entry with the financial institution, the sub-balance data structure 402 may provide the time-dependent effective APR of that single sub-balance entry. In the example of FIG. 4, the user has a first time-dependent effective APR 416-1 as a “Mixed APR” associated with Chase, a second time-dependent effective APR 416-2 of 22.99% associated with Discover, and a third time-dependent effective APR 416-3 as a “Mixed APR” associated with Citi. The example of FIG. 4 is non-limiting and serves as an example of the user interface 400 of the debt consolidation platform.

In some embodiments, the display of the mixed APR designation improves the interface by alerting the user to the presence of partition-level complexity within the financial institution's credit accounts. The mixed APR designation may prompt the user to expand the financial institution view to examine individual sub-balance entries and associated respective time-dependent effective APRs. The mixed APR designation prevents the display from presenting a misleading single APR value that would not accurately represent the interest rates applicable to the user's debt with the financial institution.

In some embodiments, the user interface 500 provides an interactive bar 418. The interactive bar 418 may include interactive GUI elements that the user can click on, tap, or otherwise interact with to view various other interfaces of the debt consolidation platform. The interactive bar 418 may persistently be displayed across interfaces of the debt consolidation platform, allowing the user to navigate between interfaces without returning to a main menu or home screen.

In some embodiments, the interactive bar 418 is located at the bottom of a user interface 500. The bottom placement of the interactive bar 418 positions the interactive GUI elements to be easily accessible by the user, for example, on a mobile device providing the debt consolidation platform. In some embodiments, the interactive bar 418 is located elsewhere within the user interface 500, such as at the top of the user interface 500, or along a side of the user interface 500. The placement of the interactive bar 418 may vary based on a form factor of the user device, the operating system conventions of the user device, or user preferences configured within the debt consolidation platform. In some embodiments, the user interface 500 does not include the interactive bar 418. In such embodiments, the user may navigate between interfaces of the debt consolidation platform using alternative navigation mechanisms.

In some embodiments, the interactive bar 418 includes a “cards” GUI element. When the user selects the “cards” GUI element within the interactive bar 418, the GUI module may render the sub-balance data structure 402. The sub-balance data structure 402 presents the credit summary 404, the one or more financial institutions 412, the debt amounts 414, and/or the time-dependent effective APRs 416 as described above. The “cards” GUI element may allow the user to view and/or examine the financial data used by the debt consolidation platform for payment schedule object calculations.

In some embodiments, the interactive bar 418 includes a “plans” GUI element. When the user selects the “plans” GUI element within the interactive bar 418, the GUI module may render a payment schedule object using a structured visualization including a timeline view and per-account allocation bars. The payment schedule object may be the same as or similar to the payment schedule object 120 as described in relation to FIG. 1 above.

In some embodiments, the interactive bar 418 includes a “progress” GUI element. When the user selects the “progress” GUI element within the interactive bar 418, the GUI module may render a progress interface presenting markers of user progress towards eliminating debt. The progress interface may display various metrics, including but not limited to total debt paid to date, percentage of original debt eliminated, cumulative interest paid, cumulative interest saved compared to minimum payment strategy, progress toward the predicted debt-free completion date, or other metrics. The progress interface may include visual indicators such as progress bars, milestone markers, or achievement badges.

In some embodiments, the interactive bar 418 includes an “offers” GUI element. When the user selects the “offers” GUI element within the interactive bar 418, the GUI module may render an offers interface displaying balance transfer offers provided by the one or more financial institutions 412. In some embodiments, the offers interface presents available balance transfer offers with associated parameters including an issuing financial institution, a promotional APR, a promotional period duration, a balance transfer fee, and/or eligibility criteria. The offers interface may rank the balance transfer offers based on projected interest savings when an offer is accepted and applied to one or more sub-balance entries.

In some embodiments, the interactive bar 418 improves the interface by providing consistent, single-tap navigation between interfaces of the debt consolidation platform. The user may access the sub-balance data structure 402, payment schedule object display, progress interface, and/or the offers interface without navigating through hierarchical menus or remembering navigation paths. The interactive bar 418 reduces a number of user interactions required to access each interface, improving usability with all features of the debt consolidation platform.

In some embodiments, the interactive bar 418 improves computational efficiency by enabling the GUI module to pre-load or cache data for each interface associated with the interactive GUI elements. The processor may anticipate that the user may select any of the interactive GUI elements and may prepare corresponding data for rapid rendering. When the user selects an interactive GUI element, the GUI module may retrieve pre-loaded data and render the corresponding interface without invoking computationally intensive operations. As such, the pre-loading may reduce latency between receiving a user selection and interface display.

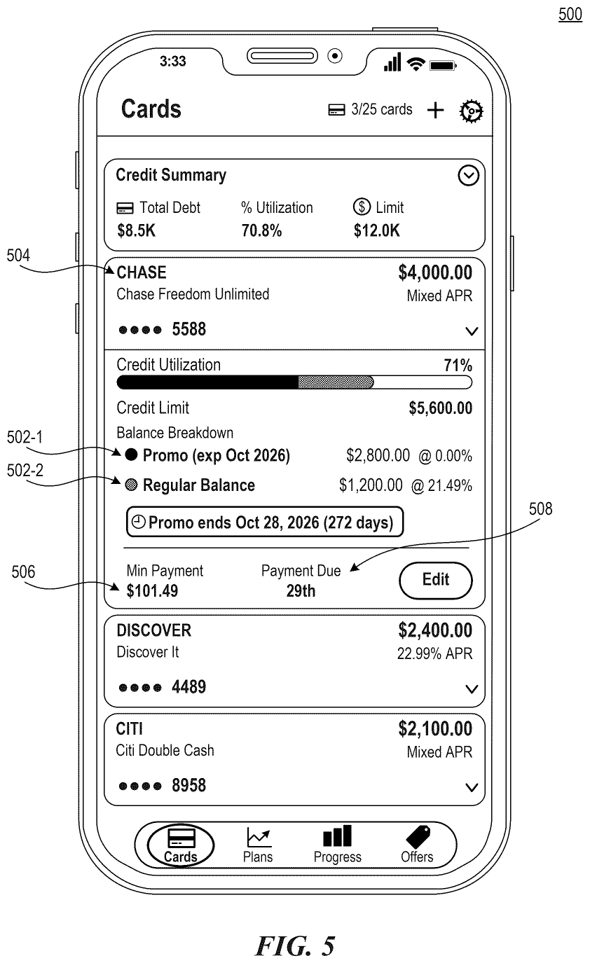

FIG. 5 illustrates a second example of a user interface 500 of a debt consolidation platform displaying sub-balance entries 502 associated with a financial institution 504. The user interface 500 may display a credit summary, which may be the same as or similar to the credit summary 404 as described in relation to FIG. 4 above. The debt consolidation platform may be the same as or similar to the debt consolidation platform 102 as described in relation to FIG. 1 above.

In some embodiments, the user selects a financial institution 504 within the user interface 500 to expand the view to reveal sub-balance entries 502 associated with the financial institution 504. In the example of FIG. 5, the user selects “Chase” to display the sub-balance entries 502 associated with Chase. The expanded view displays each sub-balance entry (e.g., first sub-balance entry 502-1, second sub-balance entry 502-2) with the associated balance amount, regular APR, promotional APR, promotional expiration timestamp, and/or time-dependent effective APR. The expanded view of the sub-balance entries 502 provides the user with partition-level detail. In the example of FIG. 5, the first sub-balance entry 502-1 is a promotional sub-balance, with a balance amount of $2,800, a time-dependent effective APR of 0%, and a promotional expiration timestamp of October 2026. In the continued example, the second sub-balance entry 502-2 is a regular balance, with a balance amount of $1,200, a time-dependent effective APR of 21.49%, and no promotional expiration timestamp, as there is no promotional APR active for the second sub-balance entry 502-2. In some embodiments, the user interface 500 also displays a minimum payment amount 506 associated with the credit account and/or the financial institution 504, as well as a payment due date 508.

In some embodiments, the display of the sub-balance data structure improves computational efficiency by rendering pre-computed values stored in the sub-balance data structure rather than recalculating values for display. The processor retrieves balance amounts, time-dependent effective APRs, and aggregate metrics from the sub-balance data structure and passes the retrieved values to the GUI module for rendering. The GUI module may then display the retrieved values without invoking the constrained optimization routine or performing interest calculations, reducing computational resource expense during rendering and displaying the sub-balance data structure.

Further, by providing an interactive sub-balance data structure, the debt consolidation platform provides an improved user interface (e.g., user interface 500) with better information than user interfaces of conventional financial platforms, through which the user can interact with the various financial institutions, credit accounts, and/or sub-balance entries 502 to view and/or understand the financial data.

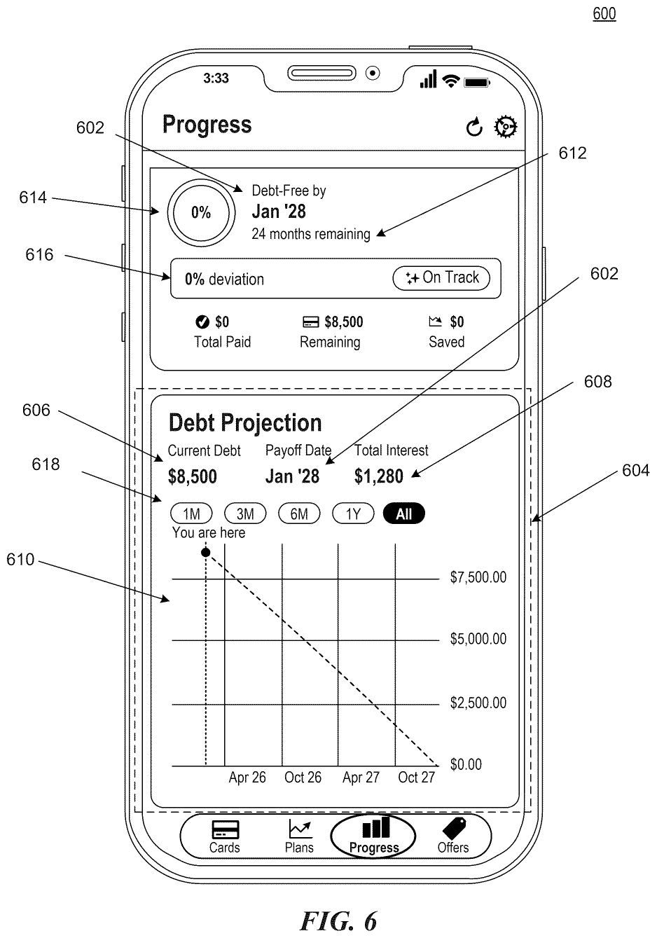

FIG. 6 illustrates an example of a payment schedule interface 600 of a debt consolidation platform. The debt consolidation platform may be the same as or similar to the debt consolidation platform 102 as described in relation to FIG. 1, above. The payment schedule interface 600 may include a rendering of a payment schedule object by a GUI module. The payment schedule object may be the same as or similar to the payment schedule object 120 as described in relation to FIG. 1, above. The GUI module may be the same as or similar to the GUI module 122 as described in relation to FIG. 1, above.

In some embodiments, the payment schedule interface 600 presents a structured visualization 604. The structured visualization 604 provides a current total amount of debt 606, a predicted debt-free completion date 602, a projected aggregate interest 608, and a timeline view 610. The projected aggregate interest 608 may be the same as or similar to the projected aggregate interest 132 as described in relation to FIG. 1, above.

In some embodiments, the current total amount of debt 606 represents a sum of balance amounts across all sub-balance entries in the sub-balance data structure at the current processing timestamp. The sub-balance data structure may be the same as or similar to the sub-balance data structure 108 as described in relation to FIG. 1 above. In the example of FIG. 6, the current total amount of debt 606 is $8,500. In some embodiments, the current total amount of debt 606 is displayed within the structured visualization 604 to inform the user of a total outstanding balance across all credit accounts.

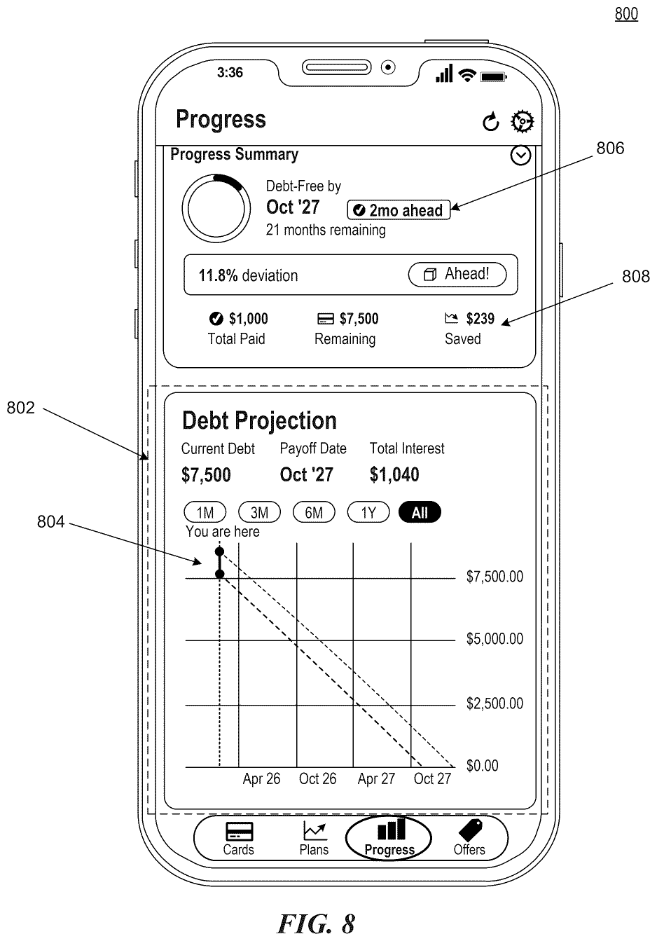

In some embodiments, the predicted debt-free completion date 602 represents a date at which all sub-balance entries are projected to reach zero balance amounts based on a set of monthly payment allocations in the payment schedule object. The predicted debt-free completion date 602 can be the same as or similar to the predicted debt-free completion date 138 as described in relation to FIG. 1 above. In the example of FIG. 8, the predicted debt-free completion date 602 is January 2028. The structured visualization 604 may display the predicted debt-free completion date 602 prominently to inform the user of a projected payoff timeline.

In some embodiments, the payment schedule interface 600 displays a number of months remaining 612 until the predicted debt-free completion date 602. In the example of FIG. 6, the number of months remaining 612 is 24 months. The number of months remaining may provide the user with a concrete timeframe for debt elimination.

In some embodiments, the payment schedule interface 600 displays a progress indicator 614 representing a percentage of debt repayment completed. In the example of FIG. 6, the progress indicator 614 displays 0%, indicating the user is at a beginning of the payment schedule.

In some embodiments, the projected aggregate interest 608 represents a total interest the user is projected to pay over the planning horizon when the user follows the set of monthly payment allocations in the payment schedule object. The projected aggregate interest 608 may be the same as or similar to the projected aggregate interest 132 as described in relation to FIG. 1 above. In the example of FIG. 6, the projected aggregate interest 608 is $1,280. The projected aggregate interest 608 allows the user to understand a total cost of debt repayment beyond purely principal balance amounts.

In some embodiments, the structured visualization 604 displays a deviation indicator 616. The deviation indicator 616 may represent a variance between the user's actual payment behavior and the projected payment amounts in the payment schedule object. In the example of FIG. 6, the deviation indicator 616 displays 0% deviation with an “On Track” status. As such, the deviation indicator 616 may inform the user whether the user is adhering to the payment schedule and/or whether the predicted debt-free completion date 602 remains accurate based on actual payments.

In some embodiments, the debt projection section includes time period filter buttons 618. The time period filter buttons 618 allow the user to select a time range for the timeline view 610, such as 1 month, 3 months, 6 months, 1 year, or all time periods. In the example of FIG. 6, the “All” time period filter button is selected, displaying an entire planning horizon in the timeline view 610.

In some embodiments, the timeline view 610 provides a line graph that indicates a progress of the user in paying off the current total amount of debt 606 based on a set of subsequent available payment allocations. The set of subsequent available payment allocations may be the same as or similar to the set of subsequent available payment allocations 136 as described in relation to FIG. 1, above. In some embodiments, the timeline view 610 displays a horizontal axis representing time periods from the current date through the predicted debt-free completion date 602. The timeline view 610 may also display a vertical axis representing balance amounts from $0.00 to the current total amount of debt 606.

In some embodiments, the timeline view 610 displays one or more projection lines showing a projected debt reduction over time. The projection lines may include a dashed line representing a projected balance trajectory based on the payment schedule object. In the example of FIG. 6, the projection line declines from the current position toward zero balance at the predicted debt-free completion date 602. The timeline view 610 may display date markers along the horizontal axis, such as April 26, October 26, April 27, and October 27 as shown in the example of FIG. 6.

In some embodiments, the payment schedule interface 600 includes the interactive bar 418 at the bottom of the interface. The interactive bar 418 includes the “Cards” GUI element, the “Plans” GUI element, the “Progress” GUI element, and the “Offers” GUI element. In the example of FIG. 8, the “Progress” GUI element is highlighted to indicate that the payment schedule interface 600 is a currently active interface.

In some embodiments, the payment schedule interface 600 improves the display of the interface by presenting the payment schedule object in a structured visual format that provides improved display of the user's debt repayment plan. For example, the timeline view 610 may provide an intuitive representation of balance reduction over time, allowing the user to visualize progress toward the predicted debt-free completion date 602 without interpreting numerical tables or spreadsheets. The structured visualization 604 consolidates key metrics including the current total amount of debt 606, the predicted debt-free completion date 602, the projected aggregate interest 608, and the deviation indicator in a single interface, reducing a need for the user to navigate between multiple screens of the debt consolidation platform to access relevant information.

In some embodiments, the payment schedule interface 600 improves computational efficiency by rendering pre-computed values from the payment schedule object. The GUI module may retrieve the predicted debt-free completion date 602, the projected aggregate interest 608, and/or the set of monthly payment allocations from the payment schedule object stored in the non-transitory memory. The GUI module may render the timeline view 610 using the pre-computed values without re-executing the constrained optimization routine or recalculating time-dependent effective APRs. As such, the pre-computed rendering reduces latency and computational resource expense when the user navigates to the payment schedule interface 600.

FIG. 6 is purely exemplary and serves to show the automatic processing performed by the debt consolidation platform, without requiring user intervention, upon receiving data records including financial data. The data records may be the same as or similar to the data records 106 as described in relation to FIG. 1, above. The structured visualization 604 may also include per-account allocation bars, but the per-account allocation bars are not shown in FIG. 6.

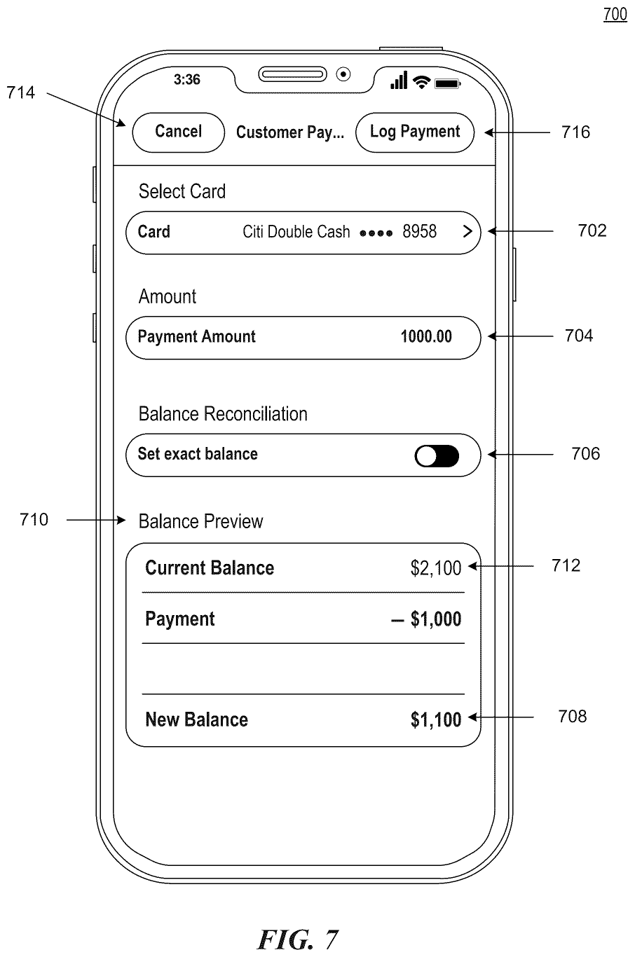

FIG. 7 illustrates an example of a restructuring event interface 700 of a debt consolidation platform. In some embodiments, the restructuring event interface 700 provides an interface within a debt consolidation platform for a user to input parameters regarding a restructuring event. The restructuring event may be the same as or similar to the restructuring event 204 as described in relation to FIG. 2, above. The debt consolidation platform may be the same as or similar to the debt consolidation platform 202 as described in relation to FIG. 2 above.

In some embodiments, the restructuring event interface 700 allows the user to record a payment made to a credit account. In the example of FIG. 7, the user inputs that a payment of $1,000 has been made to the user's Citi credit account. The restructuring event interface 700 captures payment details to allow the debt consolidation platform to update the sub-balance data structure and/or regenerate the payment schedule object based on the restructuring event.

In some embodiments, the restructuring event interface 700 includes a credit account selector 702. The user can input a credit account via the credit account selector 702. In the example of FIG. 7, the credit account is Citi Double Cash. The credit account selector 702 may display a list of credit accounts associated with the user, allowing the user to select the credit account to which the payment was made. As such, the credit account may identify which sub-balance entries in the sub-balance data structure are affected by the restructuring event.

In some embodiments, the restructuring event interface 700 includes a payment amount input field 704. The user can input a payment amount via the payment amount input field 704, for example, by typing the payment amount into the payment amount input field 704. In the example of FIG. 7, the payment amount is $1,000.00. The payment amount may represent an actual payment made by the user to the credit account. The payment amount may differ from a projected payment amount in the payment schedule object, constituting a variance restructuring event, as described above.

In some embodiments, the restructuring event interface 700 includes a balance reconciliation option 706. The balance reconciliation option may allow the user to set an exact balance rather than calculating a new balance 708 based on the payment amount. The balance reconciliation option 706 may be useful when the user's actual balance differs from a calculated balance due to interest accrual, fees, or other charges not captured in the sub-balance data structure.

In some embodiments, the restructuring event interface 700 includes a balance preview 710. The user may view the balance preview 710 to see an effect of the payment amount on the credit account before confirming the restructuring event. In some embodiments, the balance preview 710 displays a current balance 712, the payment amount as a deduction from the current balance 712, and the new balance 708. In the non-limiting example of FIG. 7, the current balance 712 is $2,100, the payment amount is $1,000 displayed as a deduction of −$1,000, and the new balance 708 is $1,100. In some embodiments, the new balance 708 is calculated by subtracting the payment amount from the current balance 712. The debt consolidation platform may perform this calculation automatically and may display the new balance 708 in the balance preview 710.

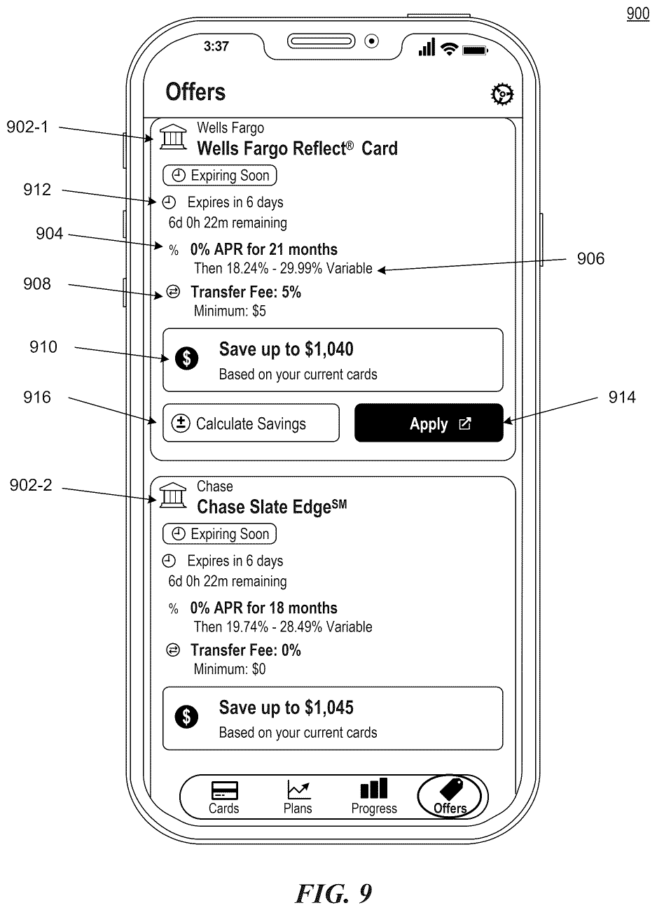

In some embodiments, the restructuring event interface 700 includes a cancellation selector 714 and/or a log payment selector 716. The cancellation selector 714 may allow the user to dismiss the restructuring event interface 700 without recording the payment. Likewise, the log payment selector 716 may allow the user to confirm the restructuring event and record the payment. In the example of FIG. 9, the cancellation selector 714 is labeled “Cancel” and the log payment selector 716 is labeled “Log Payment.”

In some embodiments, when the user selects the log payment selector 716, the debt consolidation platform automatically detects the occurrence of the restructuring event, updates the sub-balance data structure to reflect the payment amount, and/or regenerates the payment schedule object. The regenerated payment schedule object may reflect the new balance 708 for the credit account and/or recalculates the predicted debt-free completion date and the projected aggregate interest based on the updated sub-balance data structure.

In some embodiments, the restructuring event interface 700 improves the interface of the debt consolidation platform by providing a clear, guided workflow for recording payments. The balance preview 710 may allow the user to verify an effect of the payment before confirming, reducing a risk of data entry errors. In some embodiments, the restructuring event interface 700 improves computational efficiency by capturing all necessary parameters for the restructuring event in a single interface. As such, the debt consolidation platform may collect the credit account, the payment amount, and/or confirmation from the user in a single interaction, enabling the processor to update the sub-balance data structure and regenerate the payment schedule object in a single processing pass. The restructuring event interface 700 may reduce a number of partial updates to the sub-balance data structure and may likewise avoid multiple regenerations of the payment schedule object.

### Example Comparison Visualization

FIG. 8 provides an example of a comparison visualization 802 between a payment schedule object and a regenerated payment schedule object, within a comparison interface 800 of a debt consolidation platform. The payment schedule object may be based on the payment schedule object represented in relation to FIG. 6, above. The regenerated payment schedule object may be based on the restructuring event described in relation to FIG. 7, above. The comparison visualization 802 may be the same as or similar to the comparison visualization object 212 as described in relation to FIG. 2, above. The debt consolidation platform may be the same as or similar to the debt consolidation platform 102 or the debt consolidation platform 202 as described in relation to FIG. 1 or FIG. 2 above, respectively.

In some embodiments, the comparison visualization 802 provides a comparison 804, a debt-free completion date delta 806, and/or an interest savings delta 808. The comparison 804 may be the same as or similar to the comparison 216 as described in relation to FIG. 2, above. The debt-free completion date delta 806 may be the same as or similar to the debt-free completion date delta 218 as described in relation to FIG. 2, above. The interest savings delta 808 may be the same as or similar to the interest savings delta 226 as described in relation to FIG. 2, above.

In some embodiments, the debt-free completion date delta 806 indicates a difference between the predicted debt-free completion date from the payment schedule object and the updated predicted debt-free completion date from the regenerated payment schedule object. In the example of FIG. 8, the debt-free completion date delta 806 indicates that the user is 2 months ahead of schedule, informing the user that the restructuring event has accelerated a projected payoff timeline by two months.

In some embodiments, the interest savings delta 808 indicates a difference between the projected aggregate interest from the payment schedule object and the projected aggregate interest from the regenerated payment schedule object. In the example of FIG. 8, the interest savings delta 808 indicates that the user may save $239 based on the restructuring event.

In some embodiments, the comparison 804 provides a timeline view similar to the timeline view 610 as described in relation to FIG. 6, above. The comparison 804 may include a first line graph providing a representation of the payment schedule object and a second line graph providing a representation of the regenerated payment schedule object. The first line graph and the second line graph may be displayed together within the comparison 804, allowing the user to visually compare the projected debt reduction trajectories before and after the restructuring event. In the example of FIG. 8, the second line graph shows a steeper decline toward zero balance, reflecting an accelerated payoff resulting from the $1,000 payment recorded in the restructuring event interface 700.

The example of FIG. 8 is non-limiting and serves to show an ability of the debt consolidation platform to automatically recalculate and regenerate the payment schedule object upon detecting an occurrence of a restructuring event.

### Example Debt Consolidation Platform Interfaces

FIG. 9 illustrates an example of a balance transfer interface 900 of a debt consolidation platform, including balance transfer offers 902. The balance transfer interface 900 may display a first balance transfer offer 902-1 and/or a second balance transfer offer 902-2. The balance transfer interface 900 is non-limiting, and any number or type of balance transfer offer can be displayed via the balance transfer interface 900, including but not limited to the balance transfer offers 902.

In some embodiments, the debt consolidation platform aggregates the balance transfer offers 902 from one or more financial institutions. The one or more financial institutions may be the same as or similar to the one or more financial institutions 104 as described in relation to FIG. 1, above. In some embodiments, the debt consolidation platform retrieves the balance transfer offers 902 via API sessions with the one or more financial institutions, via affiliate networks, or via direct issuer APIs. The debt consolidation platform may normalize data associated with the balance transfer offers 902 into a standardized format for display within the balance transfer interface 900.

In some embodiments, the first balance transfer offer 902-1 displays a promotional APR 904, a regular APR 906, a transfer fee 908, and/or an interest savings delta 910. The interest savings delta 910 may be the same as or similar to the interest savings delta 226 as described in relation to FIG. 2, above. In the example of FIG. 9, the promotional APR 904 is 0% for 21 months. Similarly, the regular APR 906 is 18.24%-29.99% variable after the promotional expiration date of 21 months from acceptance of the first balance transfer offer 902-1. The transfer fee 908 is 5% with a minimum of $5. The interest savings delta 910 is $1,040 in the example of FIG. 9. FIG. 9 is purely exemplary and provides a non-limiting example of a balance transfer interface 900.

In some embodiments, the second balance transfer offer 902-2 displays similar parameters as the first balance transfer offer 902-1, with different values, including a promotional APR, a regular APR, a transfer fee, and an interest savings delta. In the example of FIG. 9, the second balance transfer offer 902-2 is a Chase Slate Edge card with a promotional APR of 0% for 18 months, a regular APR of 19.74%-28.49% variable after the promotional expiration date, a transfer fee of 0% with a minimum of $0, and an interest savings delta of $1,045.

In some embodiments, the balance transfer interface 900 displays an expiration indicator 912 for each balance transfer offer. The expiration indicator 912 may inform the user of a remaining amount of time to apply for the balance transfer offer before the offer expires. In the example of FIG. 9, the first balance transfer offer 902-1 displays the expiration indicator 912 indicating that the first balance transfer offer 902-1 expires in six days.

In some embodiments, when the user selects one of the balance transfer offers 902, the debt consolidation platform connects the user to a website or application portal of the financial institution associated with the balance transfer offer. The user may apply for the selected balance transfer offer through the website or application portal. In the example of FIG. 9, each balance transfer offer includes an application selector 914 that the user may select to initiate the application process.

In some embodiments, the selection of a balance transfer offer by selecting the application selector 914 results in a detection by the debt consolidation platform of a restructuring event. The restructuring event may be a second restructuring event in the scenario that a first restructuring event is the custom payment entry described in relation to FIG. 7, above. As such, the interest savings delta 910 may take into account an interest savings delta associated with the first restructuring event. The debt consolidation platform may calculate the interest savings delta 910 based on a current state of the sub-balance data structure, including any prior restructuring events that have been applied.

In some embodiments, the debt consolidation platform performs the calculations associated with the restructuring event automatically upon the user applying for a balance transfer, providing an all-inclusive platform through which the user can manage a total debt portfolio. The automatic calculation improves over conventional systems by eliminating a need for the user to manually calculate interest savings, navigate to separate websites to compare balance transfer offers, and/or track a cumulative impact of multiple complex financial decisions. Conventional systems require the user to independently research balance transfer offers, manually calculate potential savings, and/or separately manage debt repayment planning. The debt consolidation platform integrates balance transfer offers, interest savings calculation, and/or payment schedule regeneration into a unified interface, providing the ability for improved financial decision-making.

In some embodiments, the user can separately calculate savings associated with a balance transfer offer before applying. In the example of FIG. 9, each balance transfer offer includes a calculation selector 916 that the user can select to view projected savings. Selection of the calculation selector 916 may cause the debt consolidation platform to open a hypothetical scenario test interface. The hypothetical scenario test interface may be the same as or similar to the hypothetical scenario test interface 304 as described in relation to FIG. 3, above. In some embodiments, the hypothetical scenario test interface allows the user to evaluate an impact of accepting the first balance transfer offer 902-1 without committing to the offer, as described above.

In some embodiments, the balance transfer interface 900 improves the interface by presenting balance transfer offers with pre-calculated interest savings deltas specific to the user's current debt portfolio. The interest savings delta 910 may be calculated, and recalculated, based on the sub-balance entries, time-dependent effective APRs, and/or payment schedule, rather than generic estimates. The personalized interest savings delta therefore provides the user with the information to directly compare balance transfer offers 902 based on actual projected savings rather than advertised promotional terms alone.

In some embodiments, the balance transfer interface 900 improves computational efficiency by pre-calculating the interest savings delta 910 for each balance transfer offer when the balance transfer interface 900 is rendered. The processor may calculate the projected aggregate interest when each balance transfer offer is accepted and may compare the result to the projected aggregate interest from the current payment schedule object. The pre-calculated interest savings deltas may then be displayed within the balance transfer interface 900 without requiring the user to individually select each balance transfer offer to view a projected savings.

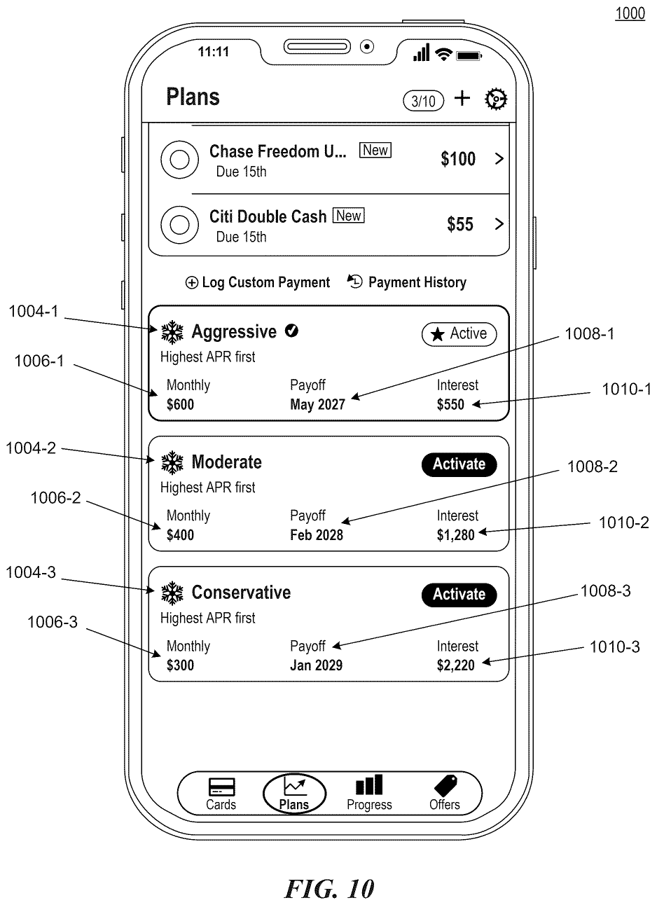

FIG. 10 illustrates an example of a hypothetical scenario test interface 1000 of a debt consolidation platform. The debt consolidation platform may be the same as or similar to the debt consolidation platform 302 as described in relation to FIG. 3, above. The hypothetical scenario test interface 1000 may be the same as or similar to the hypothetical scenario test interface 304 as described in relation to FIG. 3, above.

In some embodiments, the hypothetical scenario test interface 1000 displays a list of debt repayment hypothetical scenarios 1004. The user can specify a debt repayment hypothetical scenario from the list of debt repayment hypothetical scenarios 1004. In the example of FIG. 10, the list of debt repayment hypothetical scenarios 1004 includes a first debt repayment hypothetical scenario 1004-1, a second debt repayment hypothetical scenario 1004-2, and a third debt repayment hypothetical scenario 1004-3.

In some embodiments, the debt repayment hypothetical scenarios 1004 are displayed in association with monthly payment amounts 1006, hypothetical debt-free completion dates 1008, and/or hypothetical projected aggregate interest 1010. Each hypothetical debt-free completion date in the hypothetical debt-free completion dates 1008 may be the same as or similar to the hypothetical debt-free completion date 314 as described in relation to FIG. 3, above. The hypothetical projected aggregate interest 1010 may be the same as or similar to the hypothetical projected aggregate interest 316 as described in relation to FIG. 3, above.

In some embodiments, the first debt repayment hypothetical scenario 1004-1 is an aggressive repayment plan. In the example of FIG. 10, the first debt repayment hypothetical scenario 1004-1 may be labeled “Aggressive” and may use a highest APR first allocation strategy. In some embodiments, the first debt repayment hypothetical scenario 1004-1 is associated with a first monthly payment amount 1006-1 of $600, a first hypothetical debt-free completion date 1008-1 of May 2027, and a first hypothetical projected aggregate interest 1010-1 of $550. In the example of FIG. 10, the first debt repayment hypothetical scenario 1004-1 is displayed with an “Active” indicator, indicating that the first debt repayment hypothetical scenario 1004-1 is a currently selected hypothetical scenario.

In some embodiments, the second debt repayment hypothetical scenario 1004-2 is a moderate repayment plan. In the example of FIG. 10, the second debt repayment hypothetical scenario 1004-2 is labeled “Moderate” and may similarly use a highest APR first allocation strategy. The second debt repayment hypothetical scenario 1004-2 may be associated with a second monthly payment amount 1006-2 of $400, a second hypothetical debt-free completion date 1008-2 of February 2028, and a second hypothetical projected aggregate interest 1010-2 of $1,280.

In some embodiments, the third debt repayment hypothetical scenario 1004-3 is a conservative repayment plan. In the example of FIG. 10, the third debt repayment hypothetical scenario 1004-3 is labeled “Conservative” and may use a highest APR first allocation strategy. The third debt repayment hypothetical scenario 1004-3 is associated with a third monthly payment amount 1006-3 of $300, a third hypothetical debt-free completion date 1008-3 of January 2029, and a third hypothetical projected aggregate interest 1010-3 of $2,220.

In some embodiments, the hypothetical scenario test interface 1000 enables the user to compare the debt repayment hypothetical scenarios 1004 side-by-side. The user views the monthly payment amounts 1006, the hypothetical debt-free completion dates 1008, and the hypothetical projected aggregate interest 1010 for each debt repayment hypothetical scenario in a single interface. The side-by-side comparison allows the user to evaluate trade-offs between lower monthly payments and longer payoff timelines with higher total interest, or higher monthly payments and shorter payoff timelines with lower total interest, for example.

In some embodiments, the hypothetical scenario test interface 1000 improves the interface by presenting multiple pre-calculated debt repayment hypothetical scenarios without requiring the user to manually configure each scenario. The debt consolidation platform automatically generates the debt repayment hypothetical scenarios 1004 based on different monthly payment amounts and calculates the hypothetical debt-free completion dates 1008 and hypothetical projected aggregate interest 1010. The automatic generation reduces user effort and enables rapid comparison of repayment strategies. In some embodiments, when the user selects a hypothetical debt repayment scenario, the user can configure one or more parameters of the scenario, such as the monthly payment amount, the hypothetical debt-free completion date, and/or the hypothetical projected aggregate interest.

In some embodiments, the hypothetical scenario test interface 1000 improves computational efficiency by pre-calculating the hypothetical impact metrics for each debt repayment hypothetical scenario when the hypothetical scenario test interface 1000 is rendered. The processor generates the payment schedule for each debt repayment hypothetical scenario, calculates a hypothetical debt-free completion date and the hypothetical projected aggregate interest, and stores the results for display. The pre-calculation enables the user to view and compare multiple scenarios without incurring computational latency for each scenario.

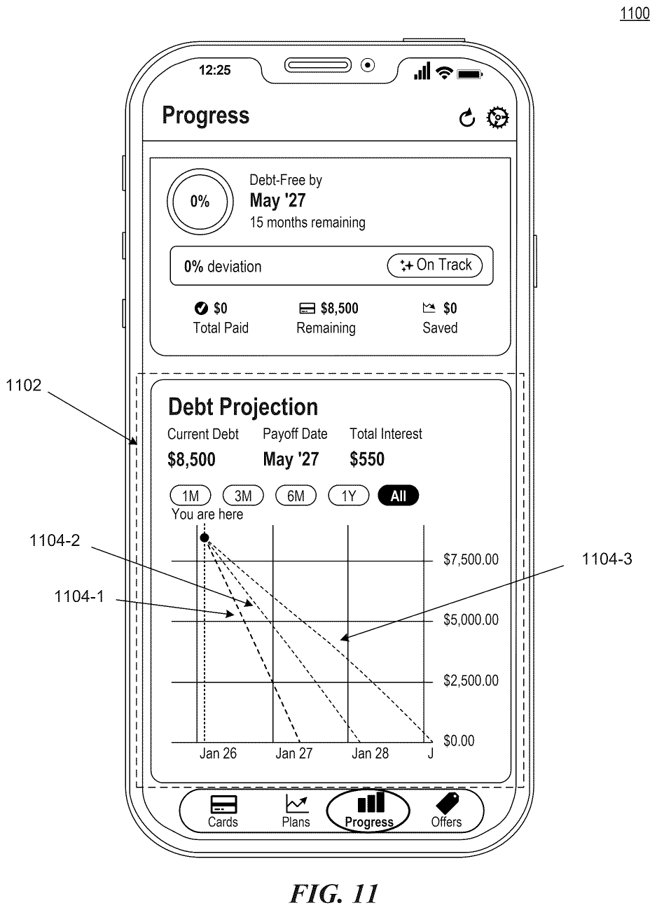

FIG. 11 illustrates a second example of a payment schedule interface 1100 of a debt consolidation platform. The debt consolidation platform may be the same as or similar to the debt consolidation platform 102 or the debt consolidation platform 302 as described in relation to FIG. 1 and FIG. 3, above, respectively.

In some embodiments, the payment schedule interface 1100 is substantially similar in layout to the payment schedule interface 600 as described in relation to FIG. 6, above. The payment schedule interface 1100, however, may display a structured visualization 1102 including a timeline view rendered by a GUI module based on the debt repayment hypothetical scenarios 1004 as described in relation to FIG. 10, above. The GUI module may be the same as or similar to the GUI module 122 as described in relation to FIG. 1, above.

In some embodiments, the timeline view in FIG. 11 includes a line graph with multiple lines 1104, each line representing a different debt repayment hypothetical scenario. For example, a first line 1104-1 may represent the first debt repayment hypothetical scenario 1004-1, a second line 1104-2 may represent the second debt repayment hypothetical scenario 1004-2, and a third line 1104-3 may represent the third debt repayment hypothetical scenario 1004-3. The structured visualization 1102 may display any number of debt repayment hypothetical scenarios as specified by the user via the hypothetical scenario test interface 1000 or a different hypothetical scenario test interface of the debt consolidation platform.

In some embodiments, as in the example shown in FIG. 11, the first line 1104-1 is steeper than the second line 1104-2 and the third line 1104-3, because the first line 1104-1 represents a most aggressive hypothetical scenario from FIG. 10 with a first monthly payment amount 1006-1 of $600, resulting in faster debt reduction and a first hypothetical debt-free completion date 1008-1 of May 2027. The second line 1104-2 may represent a moderate hypothetical scenario with a second monthly payment amount 1006-2 of $400, resulting in a second hypothetical debt-free completion date 1008-2 of February 2028. Finally, the third line 1104-3 may represent a conservative hypothetical scenario with a third monthly payment amount 1006-3 of $300, resulting in slower debt reduction and a third hypothetical debt-free completion date 1008-3 of January 2029. The varying slopes of the lines visually communicate, to the user, a relationship between monthly payment amounts and debt reduction rates.

In some embodiments, the structured visualization 1102 displays the multiple lines 1104 simultaneously within the timeline view, which allows the user to visually compare projected debt reduction trajectories of each debt repayment hypothetical scenario. As such, the user can view where each line intersects the zero-balance axis to identify the hypothetical debt-free completion date for each scenario. Likewise, the user may view the relative steepness of each line to understand how quickly debt is reduced under each scenario.

In some embodiments, the payment schedule interface 1100 improves the user interface by allowing the user to compare multiple scenarios and select a scenario that best matches financial goals of the user. The user may prioritize minimum monthly payment amount when the user has limited monthly cash flow and prefers lower payment obligations. The user may prioritize minimum repayment time when the user desires to eliminate debt as quickly as possible. The user may prioritize minimum interest expense when the user desires to minimize the total cost of debt repayment. The user may prioritize a balance of the factors based on individual financial circumstances and/or preferences. The simultaneous display of multiple debt repayment hypothetical scenarios within the structured visualization 1102 provides improvements to the payment schedule interface 1100 through which the user may evaluate trade-offs and make informed decisions without navigating between separate interfaces or relying on memory to compare scenarios.

In some embodiments, the user can select, via the payment schedule interface 1100, a debt repayment hypothetical scenario from the structured visualization 1102. The user may select one or more of the multiple lines 1104 and/or an associated selector to activate a corresponding debt repayment hypothetical scenario as an active payment schedule. Upon selection, the debt consolidation platform may update the payment schedule object to reflect the selected debt repayment hypothetical scenario.

### Example Calculating Time-Dependent Effective APRs Method Flow

FIG. 12 is a flow diagram illustrating an example method 1200 for calculating time-dependent effective APRs. The method may be implemented as a function, such as a deterministic state function, and may be the same as or similar to the function 128 as described in relation to FIG. 1 above. The method 1200 may depict a process for calculating time-dependent effective APRs based on promotional expiration dates within a debt consolidation platform. The time-dependent effective APRs may be the same as or similar to the time-dependent effective APRs 130 as described in relation to FIG. 1 above. The debt consolidation platform may be the same as or similar to the debt consolidation platform 102 as described in relation to FIG. 1 above.

The method 1200 may begin with a start operation for time-dependent APR calculation. In operation 1202, the method 1200 proceeds to an initialization operation in which a current date is set to today's date (e.g., the date at which the method 1200 is implemented) and an input is defined as a credit card portfolio with sub-balances. The credit card portfolio may correspond to the sub-balance data structure 108 including the plurality of sub-balance entries 110 as described in relation to FIG. 1, above.

In operation 1204, the method 1200 enters a loop structure that iterates through each sub-balance entry in the sub-balance data structure. For each sub-balance entry, the debt consolidation platform may read partition parameters (e.g., data fields of each sub-balance entry) including balance amount, regular APR, promotional APR, and/or promotional expiration date. The partition parameters may correspond to the distinct fields stored in each sub-balance entry of the sub-balance data structure.

In operation 1206, the method 1200 implements a decision point that evaluates, for each sub-balance entry, whether the current date is less than the promotional expiration date. In some embodiments, the decision point determines whether the promotional period is still active for the sub-balance entry. The decision point may result in the debt consolidation platform assigning the time-dependent effective APR based on the relationship between the current processing timestamp (e.g., the current date) and the promotional expiration timestamp.

In some embodiments, when the current date is less than the promotional expiration timestamp, the debt consolidation platform determines that the promotional period is still active for that sub-balance entry, and the debt consolidation platform may assign the promotional APR as the time-dependent effective APR.

In other embodiments, when the current date is equal to or greater than the promotional expiration timestamp, the debt consolidation platform determines that the promotional period has expired, and assigns the regular APR as the time-dependent effective APR.

In operation 1208, after determining the time-dependent effective APR for a sub-balance entry, the method 1200 reaches a second decision point that evaluates whether there are more sub-balance entries to process. When additional sub-balance entries remain, the method 1200 may loop back to operation 1206 for the next sub-balance entry. The processor may iterate through all sub-balance entries in the sub-balance data structure.

In some embodiments, when no additional sub-balance entries remain, the method 1200 indicates that all time-dependent effective APRs have been calculated. The method may then proceed to payment allocation optimization. The payment allocation optimization may correspond to the generation of the ranked priority list 114 and/or performing the constrained optimization routine 118 as described above.

In some embodiments, the method 1200 depicted in FIG. 12 provides accurate, repeatable calculation of time-varying interest rates (e.g., time-dependent effective APRs) across multiple sub-balance entries by evaluating each sub-balance entry independently. The method 1200 may support subsequent payment allocation optimization based on current time-dependent effective rates rather than static or averaged APR values. The method 1200 may be executed by the processor each time the sub-balance data structure is updated, each time a restructuring event is detected, or at a set cadence for recalculation of time-dependent effective APRs.

### Example Debt Consolidation Method Flow

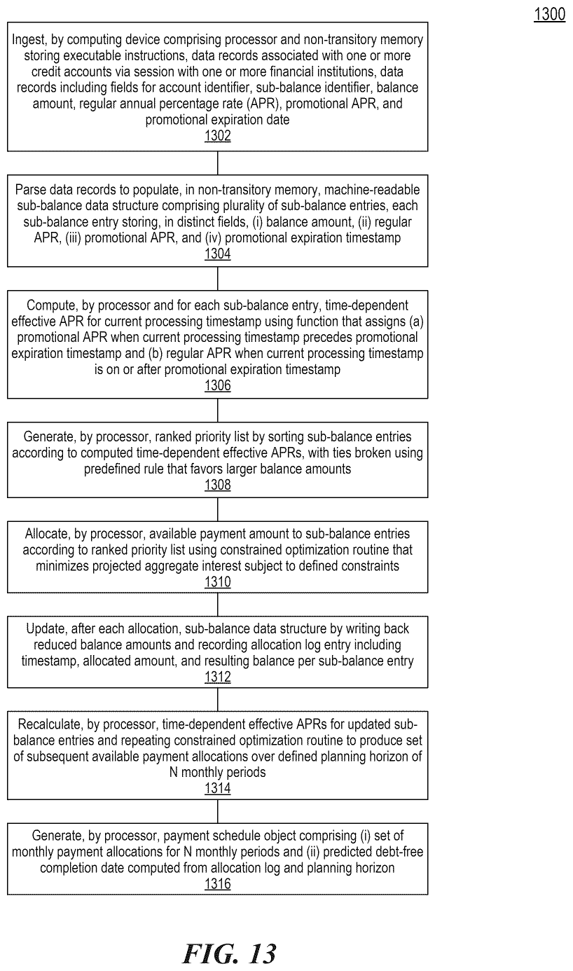

FIG. 13 is a flow diagram illustrating an example method 1300 for partition-aware credit card debt payment optimization executed by a debt consolidation platform to manage repayment of credit card debt. In some embodiments, the method 1300 is performed by components of the example computing system 1400 illustrated and described in more detail in relation to FIG. 14 below and/or the debt consolidation platform 102 as described in relation to FIG. 1 above. Likewise, embodiments can include different and/or additional operations or can perform the operations in different orders.

In operation 1302, a networked computing device comprising a processor and a non-transitory memory storing executable instructions ingests data records associated with one or more credit accounts via a session with one or more financial institutions. The data records may be standardized transaction data records that conform to a predefined schema including fields for account identifier, sub-balance identifier, balance amount, regular annual percentage rate (APR), promotional APR, and promotional expiration date. The one or more financial institutions may be the same as or similar to the one or more financial institutions 104 as described in relation to FIG. 1, above. The session may be an authenticated application programming interface (API) session with the one or more financial institutions.

In operation 1304, the data records are parsed to populate, in the non-transitory memory, a machine-readable sub-balance data structure comprising a plurality of sub-balance entries. In some embodiments, each sub-balance entry stores, in distinct fields, (i) a balance amount, (ii) a regular APR, (iii) a promotional APR, and (iv) a promotional expiration timestamp. The sub-balance data structure may be the same as or similar to the sub-balance data structure 108 as described in relation to FIG. 1, above. The sub-balance entries may be the same as or similar to the sub-balance entries 110 as described in relation to FIG. 1, above. In some embodiments, the sub-balance data structure is updated at a set cadence. The set cadence may be daily, weekly, monthly, or yearly, and is preferably monthly to align with typical payment cycles of financial institutions.

In operation 1306, the processor computes, for each sub-balance entry, a time-dependent effective APR for a current processing timestamp using a function. The function may be a deterministic state function. The deterministic state function assigns (a) the promotional APR when the current processing timestamp precedes the promotional expiration timestamp and (b) the regular APR when the current processing timestamp is on or after the promotional expiration timestamp. The time-dependent effective APR may be the same as or similar to the time-dependent effective APRs 130 as described in relation to FIG. 1, above. The function may be the same as or similar to the function 128 as described in relation to FIG. 1, above. An example of the deterministic state function is provided in relation to FIG. 12, above.

In operation 1308, the processor generates a ranked priority list by sorting the sub-balance entries according to the computed time-dependent effective APRs, with ties broken using a predefined rule that favors larger balance amounts. The ranked priority list may be the same as or similar to the ranked priority list 114 as described in relation to FIG. 1, above. In some embodiments, the predefined rule for breaking ties comprises an alternative or additional criterion beyond balance amount, such as sub-balance type, promotional expiration timestamp, account identifier, or user-defined priority.

In operation 1310, the processor allocates an available payment amount to sub-balance entries according to the ranked priority list using a constrained optimization routine that minimizes projected aggregate interest subject to constraints. In some embodiments, the constraints include any or all of (i) minimum payment rules per account, (ii) institution-specific payment application rules, and (iii) a user-defined monthly budget. The available payment amount may be the same as or similar to the available payment amount 116 as described in relation to FIG. 1, above. The constrained optimization routine may be the same as or similar to the constrained optimization routine 118 as described in relation to FIG. 1, above. The projected aggregate interest may be the same as or similar to the projected aggregate interest 132 as described in relation to FIG. 1, above. In some embodiments, the constrained optimization routine further includes determining, based on the constraints, a set of minimum payment amounts associated with the one or more credit accounts, allocating the set of minimum payment amounts to the one or more credit accounts, calculating an excess payment amount as a difference between (i) the available payment amount and (ii) a sum of the set of minimum payment amounts, and allocating the excess payment amount to a sub-balance entry with a greatest time-dependent effective APR among the plurality of sub-balance entries.

In operation 1312, after each allocation cycle, the processor updates the sub-balance data structure by writing back reduced balance amounts and/or recording an allocation log entry including a timestamp, allocated amount, and resulting balance per sub-balance entry. The allocation log allows the debt allocation platform to track payment history and detect variances between actual payment amounts and projected payment amounts.

In operation 1314, the processor recalculates the time-dependent effective APRs for the updated sub-balance entries and repeats the constrained optimization routine to produce a set of subsequent available payment allocations over a defined planning horizon of N monthly periods. The set of subsequent available payment allocations may be the same as or similar to the set of subsequent available payment allocations 136 as described in relation to FIG. 1, above. The defined planning horizon may be the same as or similar to the defined planning horizon 134 as described in relation to FIG. 1, above. In some embodiments, the time-dependent effective APRs are recalculated at a set cadence. The set cadence may be daily, weekly, monthly, or yearly, and is preferably monthly to align with typical payment cycles of financial institutions.

In operation 1316, the processor generates a payment schedule object associated with (i) a set of monthly payment allocations for the N monthly periods and (ii) a predicted debt-free completion date computed from the allocation log and the planning horizon. The payment schedule object may be the same as or similar to the payment schedule object 120 as described in relation to FIG. 1, above. The set of monthly payment allocations may be the same as or similar to the set of monthly payment allocations 140 as described in relation to FIG. 1, above. The predicted debt-free completion date may be the same as or similar to the predicted debt-free completion date 138 as described in relation to FIG. 1, above. In some embodiments, the data records are provided, as input, to an artificial intelligence (AI) agent that produces, as output, the payment schedule object. The AI agent may be the same as or similar to the AI agent 112 as described in relation to FIG. 1, above.

In some embodiments, a GUI module renders the payment schedule object using a structured visualization including a timeline view and per-account allocation bars and causes display of the timeline view and allocation bars on a user device. The GUI module may be the same as or similar to the GUI module 122 as described in relation to FIG. 1, above. The user device may be the same as or similar to the user device 124 as described in relation to FIG. 1, above. An example of the payment schedule object rendered via the structured visualization is provided in relation to FIG. 6, above.

In some embodiments, the debt consolidation platform receives a user-specified optimization goal including at least one of (i) minimizing the projected aggregate interest, (ii) achieving a debt-free status by a target date, (iii) minimizing the set of monthly payment allocations for the N monthly periods, or (iv) maximizing a credit score improvement. In such embodiments, the processor may regenerate the payment schedule object based on the user-specified optimization goal. The user-specified optimization goal may be the same as or similar to the optimization goal 228 as described in relation to FIG. 2, above.

In some embodiments, the debt consolidation platform automatically detects an occurrence of a restructuring event. The restructuring event may include one of (i) an acceptance, by a user, of a balance transfer offer to transfer a balance from a first sub-balance entry to a second sub-balance entry, (ii) an expiration of the promotional APR associated with a sub-balance entry, (iii) a variance between an actual payment amount and a projected payment amount, (iv) a change, initiated by the user, in a payment allocation strategy, or (v) an adjustment, initiated by the user, to the available payment amount. The restructuring event may be the same as or similar to the restructuring event 204 as described in relation to FIG. 2, above. In response to automatically detecting the occurrence of the restructuring event, during a session of the debt consolidation platform, the processor may automatically update one or more sub-balance entries of the sub-balance data structure to reflect the occurrence of the restructuring event.

In some embodiments, the processor regenerates the payment schedule object to produce a regenerated payment schedule object including (i) an updated set of monthly payment allocations for the N monthly periods and (ii) an updated predicted debt-free completion date. The regenerated payment schedule object may be the same as or similar to the regenerated payment schedule object 220 as described in relation to FIG. 2, above. The updated predicted debt-free completion date may be the same as or similar to the updated predicted debt-free completion date 238 as described in relation to FIG. 2, above. The updated set of monthly payment allocations may be the same as or similar to the updated set of monthly payment allocations 240 as described in relation to FIG. 2, above.

In some embodiments, the GUI module renders, during the session, a comparison visualization object presenting (i) a comparison of the payment schedule object and the regenerated payment schedule object, (ii) a debt-free completion date delta representing a difference between the predicted debt-free completion date and the updated predicted debt-free completion date, and (iii) an interest savings delta representing a difference between a first projected aggregate interest associated with the payment schedule object and a second projected aggregate interest associated with the regenerated payment schedule object. The comparison visualization object may be the same as or similar to the comparison visualization object 212 as described in relation to FIG. 2, above. The comparison may be the same as or similar to the comparison 216 as described in relation to FIG. 2, above. The debt-free completion date delta may be the same as or similar to the debt-free completion date delta 218 as described in relation to FIG. 2, above. The interest savings delta may be the same as or similar to the interest savings delta 226 as described in relation to FIG. 2, above. An example of the comparison visualization object is provided in relation to FIG. 8, above.

In some embodiments, the debt consolidation platform automatically detects a second occurrence of a second restructuring event. In such embodiments, in response to automatically detecting the second occurrence of the second restructuring event, during the session of the debt consolidation platform, the processor may automatically update one or more sub-balance entries of the sub-balance data structure to reflect the second occurrence of the second restructuring event. The processor may regenerate the regenerated payment schedule object to produce a second regenerated payment schedule object including (i) a second updated set of monthly payment allocations for the N monthly periods and (ii) a second updated predicted debt-free completion date. As such, the GUI module may render, during the session, a second comparison visualization object presenting (i) a second comparison of the second regenerated payment schedule object and the regenerated payment schedule object, (ii) a second debt-free completion date delta representing a difference between the updated predicted debt-free completion date and the second updated predicted debt-free completion date, and (iii) a second interest savings delta representing a second difference between the second projected aggregate interest and a third projected aggregate interest associated with the second regenerated payment schedule object.

In some embodiments, the debt consolidation platform renders, by the GUI module, a hypothetical scenario test interface. The user may specify, via the hypothetical scenario test interface, a hypothetical restructuring event to be applied to the payment schedule object without modifying the payment schedule object. The hypothetical scenario test interface may be the same as or similar to the hypothetical scenario test interface 304 as described in relation to FIG. 3, above. In some embodiments, the processor generates a hypothetical payment schedule object by applying the hypothetical restructuring event to the payment schedule object without modifying the payment schedule object. The hypothetical payment schedule object may be the same as or similar to the hypothetical payment schedule object 312 as described in relation to FIG. 3, above. The processor may calculate one or more hypothetical impact metrics including (i) a hypothetical debt-free completion date and (ii) a hypothetical total interest paid. The hypothetical debt-free completion date may be the same as or similar to the hypothetical debt-free completion date 314 as described in relation to FIG. 3, above. The hypothetical total interest paid may be the same as or similar to the hypothetical projected aggregate interest 316 as described in relation to FIG. 3, above.

In some embodiments, the GUI module renders the hypothetical payment schedule object alongside the payment schedule object in a non-destructive comparison mode. The non-destructive comparison mode may include one or more interactive GUI elements through which the user can alter one or more parameters of the hypothetical restructuring event. The debt consolidation platform may receive an indication, from the user, to apply the hypothetical restructuring event to the payment schedule object. The indication may be the same as or similar to the indication 318 as described in relation to FIG. 3, above. In response to receiving the indication, the processor may update the sub-balance data structure to reflect the hypothetical restructuring event and as such, may regenerate the payment schedule object. An example of the hypothetical scenario test interface is provided in relation to FIG. 10, above.

In some embodiments, the sub-balance data structure comprises a contiguous array of fixed-size records with a separate key-index heap keyed by the time-dependent effective APRs. The contiguous array can store sub-balance entries in adjacent memory locations with uniform record sizes, enabling predictable memory access patterns and improved cache utilization during sequential traversal. The key-index heap can maintain a priority ordering of sub-balance entries by time-dependent effective APR, supporting O(log n) priority updates during allocation cycles when effective APRs change due to promotional expirations or balance modifications.

In some embodiments, the deterministic state function is implemented as a two-state transition table stored in read-only memory. The two states can correspond to the promotional period being active and the promotional period being expired. The computing step can perform a single table lookup per sub-balance entry per cycle, using a comparison result between the current processing timestamp and the promotional expiration timestamp as an index into the transition table to retrieve the applicable APR value.

In some embodiments, the constrained optimization routine enforces institution-specific payment application rules by evaluating a rule bytecode executed by a sandboxed interpreter. The rule bytecode can encode payment application logic specific to each financial institution, such as whether payments are applied to the lowest-APR sub-balance first, the highest-APR sub-balance first, or proportionally across sub-balances. The sandboxed interpreter can validate each candidate allocation against the rule bytecode prior to acceptance, enabling the allocation to conforms to institution-specific rules without exposing the constrained optimization routine to arbitrary code execution.

In some embodiments, the standardized transaction data records and payment instruction payloads are encrypted in transit using TLS 1.3, and the sub-balance data structure is encrypted at rest using AES-256-GCM with per-user keys stored in a hardware-backed key store. TLS 1.3 can provide forward secrecy and authenticated encryption for data transmitted between the computing device and financial institution servers or third-party aggregator servers. The hardware-backed key store can isolate per-user encryption keys from application-level memory, preventing extraction of keys even when the application process is compromised.

In some embodiments, the write-ahead record comprises a monotonically increasing sequence number and a checksum. The sequence number can establish an ordering of allocation operations, and the checksum enables detection of corrupted or incomplete records. Recovery from an unexpected shutdown can include replaying committed records in sequence number order to reconstruct the sub-balance data structure to its last consistent state prior to the shutdown.

In some embodiments, transmitting payment instruction payloads further comprises scheduling future-dated payments by posting ISO 20022 pain.001 messages or NACHA-formatted entries to institution endpoints specified during the authenticated API session. ISO 20022 pain.001 messages can provide a standardized XML-based format for credit transfer initiation that is accepted by financial institutions supporting the ISO 20022 messaging standard. NACHA-formatted entries provide an Automated Clearing House (ACH) format for scheduling electronic fund transfers to financial institutions that accept ACH payment instructions.

In some embodiments, the ranked priority list is recomputed incrementally by updating only entries whose states changed between allocation cycles. The processor can identify sub-balance entries with modified time-dependent effective APRs, modified balance amounts, or modified promotional expiration timestamps since the previous allocation cycle, and repositions only those entries within the ranked priority list. The incremental update can reduce sort complexity below n log n on average by avoiding a full re-sort of the entire ranked priority list when only a subset of entries have changed.

In some embodiments, the GUI module receives, from the processor, a diff describing changes between successive allocation cycles. The diff can identify specific sub-balance entries, monthly periods, or allocation amounts that changed relative to the previous allocation cycle. The GUI module can apply the diff to update the timeline view and allocation bars without re-rendering unaffected elements, reducing rendering latency and computational resource expense by limiting graphical updates to the portions of the visualization that reflect changed data.

### Computer System

FIG. 14 is a block diagram that illustrates an example of a computer system 1400 in which at least some operations described herein can be implemented. As shown, the computer system 1400 can include: one or more processors 1402, main memory 1406, non-volatile memory 1410, a network interface device 1412, a display device 1418, an input/output device 1420, a control device 1422 (e.g., keyboard and pointing device), a drive unit 1424 that includes a machine-readable (storage) medium 1426, and a signal generation device 1430 that are communicatively connected to a bus 1416. The bus 1416 represents one or more physical buses and/or point-to-point connections that are connected by appropriate bridges, adapters, or controllers. Various common components (e.g., cache memory) are omitted from FIG. 14 for brevity. Instead, the computer system 1400 is intended to illustrate a hardware device on which components illustrated or described relative to the examples of the figures and any other components described in this specification can be implemented.

The computer system 1400 can take any suitable physical form. For example, the computer system 1400 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 1400. In some implementations, the computer system 1400 can be an embedded computer system, a system-on-chip (SOC), a single-board computer (SBC) system, or a distributed system such as a mesh of computer systems or include one or more cloud components in one or more networks. Where appropriate, one or more computer systems 1400 can perform operations in real time, near real time, or in batch mode.

The network interface device 1412 enables the computer system 1400 to mediate data in a network 1414 with an entity that is external to the computer system 1400 through any communication protocol supported by the computer system 1400 and the external entity. Examples of the network interface device 1412 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 1406, non-volatile memory 1410, machine-readable medium 1426) can be local, remote, or distributed. Although shown as a single medium, the machine-readable medium 1426 can include multiple media (e.g., a centralized/distributed database and/or associated caches and servers) that store one or more sets of instructions 1428. The machine-readable medium 1426 can include any medium that is capable of storing, encoding, or carrying a set of instructions for execution by the computer system 1400. The machine-readable medium 1426 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1410, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1404, 1408, 1428) set at various times in various memory and storage devices in computing device(s). When read and executed by the processor 1402, the instruction(s) cause the computer system 1400 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number can also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes are presented in a given order, alternative implementations can perform routines having steps in a different order, and some processes can be deleted, moved, added, subdivided, combined, and/or modified to provide alternative or sub-combinations. Each of these processes can be implemented in a variety of different ways. Also, while processes are at times shown as being performed in series, these processes can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that can be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A computer-implemented method executed by a debt consolidation platform to manage repayment of credit card debt, the method comprising:
ingesting, by a networked computing device comprising a processor and a non-transitory memory storing executable instructions, standardized transaction data records associated with one or more credit accounts via an authenticated application programming interface (API) session with one or more financial institutions, the standardized transaction data records conforming to a predefined schema including fields for account identifier, sub-balance identifier, balance amount, regular annual percentage rate (APR), promotional APR, and promotional expiration date;
parsing the standardized transaction data records to populate, in the non-transitory memory, a machine-readable sub-balance data structure comprising a plurality of sub-balance entries, each sub-balance entry storing, in distinct fields, (i) a balance amount, (ii) a regular APR, (iii) a promotional APR, and (iv) a promotional expiration timestamp;
computing, by the processor and for each sub-balance entry, a time-dependent effective APR for a current processing timestamp using a deterministic state function that assigns (a) the promotional APR when the current processing timestamp precedes the promotional expiration timestamp and (b) the regular APR when the current processing timestamp is on or after the promotional expiration timestamp;
generating, by the processor, a ranked priority list by sorting sub-balance entries according to computed time-dependent effective APRs, with ties broken using a predefined rule;
allocating, by the processor, an available payment amount to sub-balance entries according to the ranked priority list using a constrained optimization routine that minimizes projected aggregate interest subject to constraints comprising: (i) minimum payment rules per account, (ii) institution-specific payment application rules, and (iii) a user-defined monthly budget;
updating, after each allocation cycle, the sub-balance data structure by writing back reduced balance amounts and recording an allocation log entry including a timestamp, allocated amount, and resulting balance per sub-balance entry;
recalculating, by the processor, the time-dependent effective APRs for the updated sub-balance entries and repeating the constrained optimization routine to produce a set of subsequent available payment allocations over a defined planning horizon of N monthly periods;
generating, by the processor, a payment schedule object comprising (i) a set of monthly payment allocations for the N monthly periods and (ii) a predicted debt-free completion date computed from the allocation log and the planning horizon; and
rendering, by a graphical user interface (GUI) module, the payment schedule object using a structured visualization comprising a timeline view and per-account allocation bars, and causing display of the timeline view and allocation bars on a user device.

2. The computer-implemented method of claim 1, wherein the time-dependent effective APRs are recalculated at a set cadence.

3. The computer-implemented method of claim 1, further comprising:
automatically detecting an occurrence of a restructuring event,
wherein the restructuring event includes one of (i) an acceptance, by a user, of a balance transfer offer to transfer a balance from a first sub-balance entry to a second sub-balance entry, (ii) an expiration of the promotional APR associated with a sub-balance entry, (iii) a variance between an actual payment amount and a projected payment amount, (iv) a change, initiated by the user, in a payment allocation strategy, or (v) an adjustment, initiated by the user, to the available payment amount;
in response to automatically detecting the occurrence of the restructuring event, during a session of the debt consolidation platform, automatically updating the sub-balance data structure to reflect the occurrence of the restructuring event;
regenerating, by the processor, the payment schedule object to produce a regenerated payment schedule object comprising (i) an updated set of monthly payment allocations for the N monthly periods and (ii) an updated predicted debt-free completion date; and
rendering, by the GUI module and during the session, a comparison visualization object presenting (i) a comparison of the payment schedule object and the regenerated payment schedule object, (ii) a debt-free completion date delta representing a difference between the predicted debt-free completion date and the updated predicted debt-free completion date, and (iii) an interest savings delta representing a difference between a first projected aggregate interest associated with the payment schedule object and a second projected aggregate interest associated with the regenerated payment schedule object and causing display of the comparison visualization object on the user device.

4. The computer-implemented method of claim 3, further comprising:
automatically detecting a second occurrence of a second restructuring event;
in response to automatically detecting the second occurrence of the second restructuring event, during the session of the debt consolidation platform, automatically updating the sub-balance data structure to reflect the second occurrence of the second restructuring event,
regenerating, by the processor, the regenerated payment schedule object to produce a second regenerated payment schedule object comprising (i) a second updated set of monthly payment allocations for the N monthly periods and (ii) a second updated predicted debt-free completion date; and
rendering, by the GUI module and during the session, a second comparison visualization object presenting (i) a second comparison of the second regenerated payment schedule object and the regenerated payment schedule object, (ii) a second debt-free completion date delta representing a difference between the updated predicted debt-free completion date and the second updated predicted debt-free completion date, and (iii) a second interest savings delta representing a second difference between the second projected aggregate interest and a third projected aggregate interest associated with the second regenerated payment schedule object and causing display of the second comparison visualization object on the user device.

5. The computer-implemented method of claim 1, wherein allocating the available payment amount using the constrained optimization routine further comprises:
determining, by the processor and based on the constraints, a set of minimum payment amounts associated with the one or more credit accounts;
allocating, by the processor, the set of minimum payment amounts to the one or more credit accounts;
calculating, by the processor, an excess payment amount as a difference between (i) the available payment amount and (ii) a sum of the set of minimum payment amounts; and
allocating, by the processor, the excess payment amount to a sub-balance entry having a highest time-dependent effective APR.

6. The computer-implemented method of claim 1, further comprising:
receiving a user-specified optimization goal including at least one of (i) minimizing the projected aggregate interest, (ii) achieving a debt-free status by a target date, (iii) minimizing the set of monthly payment allocations for the N monthly periods, or (iv) maximizing a credit score improvement; and
automatically regenerating, by the processor, the ranked priority list based on the user-specified optimization goal.

7. The computer-implemented method of claim 1, further comprising:
rendering, by the GUI module, a hypothetical scenario test interface and causing display of the hypothetical scenario test interface on the user device,
wherein a user specifies, via the hypothetical scenario test interface a hypothetical restructuring event to be applied to the payment schedule object without modifying the payment schedule object;
generating, by the processor, a hypothetical payment schedule object by applying the hypothetical restructuring event to the payment schedule object without modifying the payment schedule object;
calculating, by the processor, a set of hypothetical impact metrics including (i) a hypothetical debt-free completion date and (ii) a hypothetical projected aggregate interest,
rendering, by the GUI module, the hypothetical payment schedule object alongside the payment schedule object in a non-destructive comparison mode and causing display of the non-destructive comparison mode on the user device within the hypothetical scenario test interface;
wherein the non-destructive comparison mode provides one or more interactive GUI elements through which the user can alter one or more parameters of the hypothetical restructuring event;
receiving an indication, from the user, to apply the hypothetical restructuring event to the payment schedule object; and
in response to receiving the indication, updating the sub-balance data structure to reflect the hypothetical restructuring event and regenerating, by the processor, the payment schedule object.

8. The computer-implemented method of claim 1, further comprising:
providing the standardized transaction data records, as input, to an artificial intelligence (AI) agent that generates, as output, the payment schedule object.

9. A computer-implemented method for managing credit card debt repayment via a debt consolidation platform comprising:
ingesting, by a computing device comprising a processor and a non-transitory memory storing executable instructions, data records associated with one or more credit accounts via a session with one or more financial institutions, the data records including fields for account identifier, sub-balance identifier, balance amount, regular annual percentage rate (APR), promotional APR, and promotional expiration date;
parsing the data records to populate, in the non-transitory memory, a machine-readable sub-balance data structure comprising a plurality of sub-balance entries, each sub-balance entry storing, in distinct fields, (i) a balance amount, (ii) a regular APR, (iii) a promotional APR, and (iv) a promotional expiration timestamp;
computing, by the processor and for each sub-balance entry, a time-dependent effective APR for a current processing timestamp using a function that assigns (a) the promotional APR when the current processing timestamp precedes the promotional expiration timestamp and (b) the regular APR when the current processing timestamp is on or after the promotional expiration timestamp;
generating, by the processor, a ranked priority list by sorting sub-balance entries according to computed time-dependent effective APRs, with ties broken using a predefined rule;
allocating, by the processor, an available payment amount to sub-balance entries according to the ranked priority list using a constrained optimization routine that minimizes projected aggregate interest subject to defined constraints;
updating, after each allocation, the sub-balance data structure by writing back reduced balance amounts and recording an allocation log entry including a timestamp, allocated amount, and resulting balance per sub-balance entry;
recalculating, by the processor, the time-dependent effective APRs for the updated sub-balance entries and repeating the constrained optimization routine to produce a set of subsequent available payment allocations over a defined planning horizon of N monthly periods; and
generating, by the processor, a payment schedule object comprising (i) a set of monthly payment allocations for the N monthly periods and (ii) a predicted debt-free completion date computed from the allocation log and the planning horizon.

10. The computer-implemented method of claim 9, further comprising:
providing the data records, as input, to an artificial intelligence (AI) agent that generates, as output, the payment schedule object.

11. The computer-implemented method of claim 9, further comprising:
rendering, by a graphical user interface (GUI) module, the payment schedule object using a structured visualization comprising a timeline view and per-account allocation bars, and causing display of the timeline view and allocation bars on a user device.

12. The computer-implemented method of claim 9, wherein the time-dependent effective APRs are recalculated at a set cadence.

13. The computer-implemented method of claim 9, further comprising:
automatically detecting an occurrence of a restructuring event;
wherein the restructuring event includes one of (i) an acceptance, by a user, of a balance transfer offer to transfer a balance from a first sub-balance entry to a second sub-balance entry, (ii) an expiration of the promotional APR associated with a sub-balance entry, (iii) a variance between an actual payment amount and a projected payment amount, (iv) a change, initiated by the user, in a payment allocation strategy, or (v) an adjustment, initiated by the user, to the available payment amount;
in response to automatically detecting the occurrence of the restructuring event, during a session of the debt consolidation platform, automatically updating the sub-balance data structure to reflect the occurrence of the restructuring event,
regenerating, by the processor, the payment schedule object to produce a regenerated payment schedule object comprising (i) an updated set of monthly payment allocations for the N monthly periods and (ii) an updated predicted debt-free completion date; and
rendering, by a GUI module and during the session, a comparison visualization object presenting (i) a comparison of the payment schedule object and the regenerated payment schedule object, (ii) a debt-free completion date delta representing a difference between the predicted debt-free completion date and the updated predicted debt-free completion date, and (iii) an interest savings delta representing a difference between a first projected aggregate interest associated with the payment schedule object and a second projected aggregate interest associated with the regenerated payment schedule object and causing display of the comparison visualization object on a user device.

14. The computer-implemented method of claim 13, further comprising:
automatically detecting a second occurrence of a second restructuring event;
in response to automatically detecting the second occurrence of the second restructuring event, during the session of the debt consolidation platform, automatically updating the sub-balance data structure to reflect the second occurrence of the second restructuring event,
regenerating, by the processor, the regenerated payment schedule object to produce a second regenerated payment schedule object comprising (i) a second updated set of monthly payment allocations for the N monthly periods and (ii) a second updated predicted debt-free completion date; and
rendering, by the GUI module and during the session, a second comparison visualization object presenting (i) a second comparison of the second regenerated payment schedule object and the regenerated payment schedule object, (ii) a second debt-free completion date delta representing a difference between the updated predicted debt-free completion date and the second updated predicted debt-free completion date, and (iii) a second interest savings delta representing a second difference between the second projected aggregate interest and a third projected aggregate interest associated with the second regenerated payment schedule object and causing display of the second comparison visualization object on the user device.

15. The computer-implemented method of claim 9, further comprising:
receiving a user-specified optimization goal including at least one of (i) minimizing the projected aggregate interest, (ii) achieving a debt-free status by a target date, (iii) minimizing the set of monthly payment allocations for the N monthly periods, or (iv) maximizing a credit score improvement; and
automatically regenerating, by the processor, the ranked priority list based on the user-specified optimization goal.

16. The computer-implemented method of claim 9, further comprising:
rendering, by a GUI module, a hypothetical scenario test interface and causing
display of the hypothetical scenario test interface on a user device,
wherein a user specifies, via the hypothetical scenario test interface a hypothetical restructuring event to be applied to the payment schedule object without modifying the payment schedule object;
generating, by the processor, a hypothetical payment schedule object by applying the hypothetical restructuring event to the payment schedule object without modifying the payment schedule object;
calculating, by the processor, a set of hypothetical impact metrics including (i) a hypothetical debt-free completion date and (ii) a hypothetical projected aggregate interest,
rendering, by the GUI module, the hypothetical payment schedule object alongside the payment schedule object in a non-destructive comparison mode and causing display of the non-destructive comparison mode on the user device within the hypothetical scenario test interface;
wherein the non-destructive comparison mode provides one or more interactive GUI elements through which the user can alter one or more parameters of the hypothetical restructuring event;
receiving an indication, from the user, to apply the hypothetical restructuring event to the payment schedule object; and
in response to receiving the indication, updating the sub-balance data structure to reflect the hypothetical restructuring event and regenerating, by the processor, the payment schedule object.

17. One or more non-transitory, computer-readable storage media, comprising instructions recorded thereon, wherein the instructions, when executed by at least one data processor of a system hosting a debt consolidation platform, cause the system to:
ingest, by a computing device comprising a processor and a non-transitory memory storing executable instructions, data records associated with one or more credit accounts via a session with one or more financial institutions, the data records including fields for account identifier, sub-balance identifier, balance amount, regular annual percentage rate (APR), promotional APR, and promotional expiration date;
parse the data records to populate, in the non-transitory memory, a machine-readable sub-balance data structure comprising a plurality of sub-balance entries, each sub-balance entry storing, in distinct fields, (i) a balance amount, (ii) a regular APR, (iii) a promotional APR, and (iv) a promotional expiration timestamp;
compute, by the processor and for each sub-balance entry, a time-dependent effective APR for a current processing timestamp using a function that assigns (a) the promotional APR when the current processing timestamp precedes the promotional expiration timestamp and (b) the regular APR when the current processing timestamp is on or after the promotional expiration timestamp;
generate, by the processor, a ranked priority list by sorting sub-balance entries according to computed time-dependent effective APRs, with ties broken using a predefined rule;
allocate, by the processor, an available payment amount to sub-balance entries according to the ranked priority list using a constrained optimization routine that minimizes projected aggregate interest subject to defined constraints;
update, after each allocation, the sub-balance data structure by writing back reduced balance amounts and recording an allocation log entry including a timestamp, allocated amount, and resulting balance per sub-balance entry;
recalculate, by the processor, the time-dependent effective APRs for the updated sub-balance entries and repeating the constrained optimization routine to produce a set of subsequent available payment allocations over a defined planning horizon of N monthly periods; and
generate, by the processor, a payment schedule object comprising (i) a set of monthly payment allocations for the N monthly periods and (ii) a predicted debt-free completion date computed from the allocation log and the planning horizon.

18. The one or more non-transitory, computer-readable storage media of claim 17, further comprising instructions that, when executed, cause the system to:
render, by a graphical user interface (GUI) module, the payment schedule object using a structured visualization comprising a timeline view and per-account allocation bars, and cause display of the timeline view and allocation bars on a user device.

19. The one or more non-transitory, computer-readable storage media of claim 17, further comprising instructions that, when executed, cause the system to:
automatically detect an occurrence of a restructuring event;
wherein the restructuring event includes one of (i) an acceptance, by a user, of a balance transfer offer to transfer a balance from a first sub-balance entry to a second sub-balance entry, (ii) an expiration of the promotional APR associated with a sub-balance entry, (iii) a variance between an actual payment amount and a projected payment amount, (iv) a change, initiated by the user, in a payment allocation strategy, or (v) an adjustment, initiated by the user, to the available payment amount;
in response to automatically detecting the occurrence of the restructuring event, during a session of the debt consolidation platform, automatically update the sub-balance data structure to reflect the occurrence of the restructuring event,
regenerate, by the processor, the payment schedule object to produce a regenerated payment schedule object comprising (i) an updated set of monthly payment allocations for the N monthly periods and (ii) an updated predicted debt-free completion date; and
render, by a GUI module and during the session, a comparison visualization object presenting (i) a comparison of the payment schedule object and the regenerated payment schedule object, (ii) a debt-free completion date delta representing a difference between the predicted debt-free completion date and the updated predicted debt-free completion date, and (iii) an interest savings delta representing a difference between a first projected aggregate interest associated with the payment schedule object and a second projected aggregate interest associated with the regenerated payment schedule object and cause display of the comparison visualization object on a user device.

20. The one or more non-transitory, computer-readable storage media of claim 17, further comprising instructions that, when executed, cause the system to:
render, by a GUI module, a hypothetical scenario test interface and cause display of the hypothetical scenario test interface on a user device,
wherein a user specifies, via the hypothetical scenario test interface a hypothetical restructuring event to be applied to the payment schedule object without modifying the payment schedule object;
generate, by the processor, a hypothetical payment schedule object by applying the hypothetical restructuring event to the payment schedule object without modifying the payment schedule object;
calculate, by the processor, a set of hypothetical impact metrics including (i) a hypothetical debt-free completion date and (ii) a hypothetical projected aggregate interest,
render, by the GUI module, the hypothetical payment schedule object alongside the payment schedule object in a non-destructive comparison mode and cause display of the non-destructive comparison mode on the user device;
wherein the non-destructive comparison mode provides one or more interactive GUI elements through which the user can alter one or more parameters of the hypothetical restructuring event;
receive an indication, from the user, to apply the hypothetical restructuring event to the payment schedule object; and
in response to receiving the indication, update the sub-balance data structure to reflect the hypothetical restructuring event and regenerating, by the processor, the payment schedule o
